(19) United States
(12) Patent Application Publication
(10) Pub. No.: US 2026/0004086 A1
(43) Pub. Date: Jan. 1, 2026

(54) MULTIMODAL ENTITY EXTRACTION, ONTOLOGY MAPPING, AND IMPACT-BASED SENTIMENT ANALYSIS USING LARGE LANGUAGE MODELS

(71) Applicant: ZS Associates, Inc., Evanston, IL (US)

(72) Inventors: Russell Evans, Austin, TX (US); Tim Joyce, Chicago, IL (US); Srinivas Chilukuri, Buffalo Grove, IL (US); Rahul Sarkar, Bengaluru (IN); Eric Swank, River Forest, IL (US); Faisal Khaled, New York, NY (US); Utkarsh Verma, Bengaluru (IN); Shantam Shreshta, Bengaluru (IN); Sourish Bakshi, Bengaluru (IN)

(73) Assignee: ZS Associates, Inc., Evanston, IL (US)

(21) Appl. No.: 19/248,985

(22) Filed: Jun. 25, 2025

Related U.S. Application Data
(60) Provisional application No. 63/664,593, filed on Jun. 26, 2024.

(51) Int. Cl. G06F 40/40; G06F 16/34; G06F 40/30

(52) U.S. Cl. CPC G06F 40/40; G06F 16/34; G06F 40/30

(57) ABSTRACT

A method comprising retrieving one or more requirements of knowledge to be extracted; generating a prompt corresponding to the one or more requirements; validating the prompt by executing a large language model using the prompt and evaluating the response predicted by the large language model; fine-tuning the large language model using validation data generated as a result of validating the prompt; and executing the fine-tuned large language model using a text corpus to analyze one or more item reviews and generate a pair of at least one entity and a respective relationship sentiment value for the entity.

### CROSS-REFERENCE TO RELATED APPLICATIONS

This application claims priority to U.S. Provisional Patent Application No. 63/664,593, filed Jun. 26, 2024, which is incorporated herein by reference in its entirety for all purposes.

### TECHNICAL FIELD

The present disclosure relates to the field of artificial intelligence-natural language processing for entity extraction and disambiguation, relationship extraction, ontology development, sentiment values, key driver and feature importance analysis and trend identification, impact calculation and classification from any textual material that may be extracted from multiple data sources.

### BACKGROUND

Artificial intelligence (AI) models, such as classification models and regression models, can be used to process a variety of input data. Generally, artificial intelligence models are created and trained to address application-specific problems. Manually training models on unstructured datasets is challenging because information is often stored in a variety of different formats.

Most Natural Language Processing (NLP) models require fine tuning models for different industries or different categories of text. For instance, in order to produce results, different NLP models can be fine-tuned for the medical or legal industry. This is undesirable because these NLP models generally cannot scale easily to new domains/categories. Moreover, in situations where multiple domains/categories are relevant, it is undesirable to train and maintain multiple NLP models.

### SUMMARY

For the aforementioned reasons, there is a need to improve processes to train and execute machine-learning models using structured and/or unstructured data from multiple data sources. The techniques described herein include the training and execution of a machine-learning pipeline that includes one or more machine-learning models. The techniques described herein can be used, for example, to generate actionable, interpretable outputs from unstructured data retrieved from multiple sources, such as e-commerce websites, social media websites, investor reports, and consumer interactions. The machine-learning techniques described herein include the training and execution of large language models (LLMs), which can be utilized to generate human-readable graphical interfaces.

The methods and systems discussed herein can be applied to any text (extracted via various methods discussed herein) to perform entity extraction and disambiguation, relationship extraction, ontology development, sentiment analysis, key driver and feature importance analysis, and/or trend identification and classification. Certain aspects of the embodiments discussed herein are described within the context of “reviews” extracted from one or more websites. However, the methods and systems discussed herein can be applied to text extracted from data sources that involve raw text responses and/or a KPI measure. Non-limiting examples of the text applicable to the methods and systems discussed herein can include review data (e.g., text response relative to star rating), voice of customer survey data (e.g., text response relative to net promoter score, customer satisfaction score, and the like), social media data (e.g., comment text relative to engagement metrics (e.g., likes, replies)), and/or call center data (e.g., transcribed call logs relative to operational metrics (e.g., call length)).

The method and systems discussed herein outline the development and application of machine-learning models, specifically focusing on extracting insights from diverse data sources, including structured and/or unstructured data, such as images, product metadata, and the like. The methods and systems discussed herein improve training and execution of machine-learning models using both structured and unstructured data from various sources like e-commerce and social media sites, company reports, and customer interactions. The paradigms discussed herein can effectively handle large language models (LLMs) and generate interpretable, actionable outputs.

The methods and systems described herein can utilize various techniques (e.g., machine learning methodologies) to process text data to perform complex tasks such as entity extraction and disambiguation, relationship extraction, sentiment analysis, and trend identification. The discussed model can be flexible, such that the apply to different types of data, including those paired with key performance indicators (KPIs) like net promoter scores or customer satisfaction metrics.

To ensure the systems and methods discussed herein can scale effectively across large datasets, the architecture may incorporate runtime optimizations that significantly reduce processing latency. These include parallel processing to distribute workloads across multiple compute threads, selective inference to limit model execution to only the most relevant data segments, and intelligent caching of intermediate results such as embeddings and prompt completions to avoid redundant computation. Additionally, token-level cost optimization techniques—such as prompt compression, truncation, and dynamic shaping—may be employed to minimize the number of tokens processed by large language models, thereby reducing both latency and computational expense. Together, these strategies enable the system to efficiently process millions of unstructured inputs with high throughput and responsiveness.

In some aspects, the techniques described herein relate to a computer-implemented method for generating interpretable analytic outputs from unstructured data, the method including: ingesting, by at least one processor, review data; automatically generating, by the at least one processor, in response to at least one user-specified analytic requirement, a prompt configured for use with a large language model (LLM); executing, by the at least one processor, the LLM with the prompt to create, for at least one portion of the review data, a plurality of candidate concepts, a corresponding context phrase, and an initial sentiment polarity associated with the context phrase; determining, by the at least one processor, for at least one candidate concept, an embedding vector within an embedding space, the embedding vector being transformed by a learned embedding-transformation matrix to correspond to semantic dimensions associated with the analytic requirement; mapping, by the at least one processor, at least one embedding vector to a node of a hierarchical ontology by comparing the at least one embedding vector to existing ontology node vectors according to a similarity metric; populating, by the at least one processor, a feature matrix that associates the mapped ontology node with the sentiment polarity and a key performance indicator (KPI) value corresponding review data; training, by the at least one processor using the feature matrix, a predictive impact model that yields, a contribution value estimating an influence of the node's sentiment polarity on the KPI value; and generating, by the at least one processor, at least one interactive graphical user interface that displays the contribution value produced by the predictive impact model.

In some aspects, the techniques described herein relate to a method, wherein ingesting the review data includes retrieving unstructured text from a plurality of heterogeneous data sources corresponding to at least one of an e-commerce website, a social-media platform, a voice-of-customer survey, a call-center transcript, or an investor report.

In some aspects, the techniques described herein relate to a method, wherein automatically generating the prompt further includes selecting one or more representative few-shot examples and compressing the prompt to satisfy a predefined token budget.

In some aspects, the techniques described herein relate to a method, wherein executing the LLM further includes: applying, by the at least one processor, a set of post-processing prompts to the plurality of candidate concepts to extract, at finer granularity, product attributes, consumer needs, occasions, or preparation methods.

In some aspects, the techniques described herein relate to a method, wherein training the predictive impact model includes fitting a gradient-boosted decision-tree regressor and computing SHAP values to derive the contribution value for each mapped ontology node.

In some aspects, the techniques described herein relate to a method, further including: fine-tuning, by the at least one processor, the LLM with a training corpus of prompt-completion pairs generated from validated candidate concepts and sentiment polarities, thereby reducing inference latency and improving concept-extraction accuracy.

In some aspects, the techniques described herein relate to a method, further including: executing, by the at least one processor, a runtime optimization protocol that employs parallel processing, selective inference of relevant text segments, and adaptive caching of intermediate results to reduce total processing latency and computational cost.

In some aspects, the techniques described herein relate to a computer system for generating interpretable analytic outputs from unstructured data, the computer system including a computer-readable medium having a set of non-transitory instructions that when executed, cause at least one processor to: ingest review data; automatically generate in response to at least one user-specified analytic requirement, a prompt configured for use with a large language model (LLM); execute the LLM with the prompt to create, for at least one portion of the review data, a plurality of candidate concepts, a corresponding context phrase, and an initial sentiment polarity associated with the context phrase; determine for at least one candidate concept, an embedding vector within an embedding space, the embedding vector being transformed by a learned embedding-transformation matrix to correspond to semantic dimensions associated with the analytic requirement; map at least one embedding vector to a node of a hierarchical ontology by comparing the at least one embedding vector to existing ontology node vectors according to a similarity metric; populate a feature matrix that associates the mapped ontology node with the sentiment polarity and a key performance indicator (KPI) value corresponding review data; train, using the feature matrix, a predictive impact model that yields, a contribution value estimating an influence of the node's sentiment polarity on the KPI value; and generate at least one interactive graphical user interface that displays the contribution value produced by the predictive impact model.

In some aspects, the techniques described herein relate to a computer system, wherein ingesting the review data includes retrieving unstructured text from a plurality of heterogeneous data sources corresponding to at least one of an e-commerce website, a social-media platform, a voice-of-customer survey, a call-center transcript, or an investor report.

In some aspects, the techniques described herein relate to a computer system, wherein automatically generating the prompt further includes selecting one or more representative few-shot examples and compressing the prompt to satisfy a predefined token budget.

In some aspects, the techniques described herein relate to a computer system, wherein executing the LLM further includes: applying a set of post-processing prompts to the plurality of candidate concepts to extract, at finer granularity, product attributes, consumer needs, occasions, or preparation methods.

In some aspects, the techniques described herein relate to a computer system, wherein training the predictive impact model includes fitting a gradient-boosted decision-tree regressor and computing SHAP values to derive the contribution value for each mapped ontology node.

In some aspects, the techniques described herein relate to a computer system, wherein the instructions further cause the at least one processor to: fine-tune the LLM with a training corpus of prompt-completion pairs generated from validated candidate concepts and sentiment polarities, thereby reducing inference latency and improving concept-extraction accuracy.

In some aspects, the techniques described herein relate to a computer system, wherein the instructions further cause the at least one processor to: execute a runtime optimization protocol that employs parallel processing, selective inference of relevant text segments, and adaptive caching of intermediate results to reduce total processing latency and computational cost.

In some aspects, the techniques described herein relate to a computer system for generating interpretable analytic outputs from unstructured data, the computer system including at least one processor configured to: ingest review data; automatically generate in response to at least one user-specified analytic requirement, a prompt configured for use with a large language model (LLM); execute the LLM with the prompt to create, for at least one portion of the review data, a plurality of candidate concepts, a corresponding context phrase, and an initial sentiment polarity associated with the context phrase; determine for at least one candidate concept, an embedding vector within an embedding space, the embedding vector being transformed by a learned embedding-transformation matrix to correspond to semantic dimensions associated with the analytic requirement; map at least one embedding vector to a node of a hierarchical ontology by comparing the at least one embedding vector to existing ontology node vectors according to a similarity metric; populate a feature matrix that associates the mapped ontology node with the sentiment polarity and a key performance indicator (KPI) value corresponding review data; train, using the feature matrix, a predictive impact model that yields, a contribution value estimating an influence of the node's sentiment polarity on the KPI value; and generate at least one interactive graphical user interface that displays the contribution value produced by the predictive impact model.

In some aspects, the techniques described herein relate to a computer system, wherein ingesting the review data includes retrieving unstructured text from a plurality of heterogeneous data sources corresponding to at least one of an e-commerce website, a social-media platform, a voice-of-customer survey, a call-center transcript, or an investor report.

In some aspects, the techniques described herein relate to a computer system, wherein automatically generating the prompt further includes selecting one or more representative few-shot examples and compressing the prompt to satisfy a predefined token budget.

In some aspects, the techniques described herein relate to a computer system, wherein executing the LLM further includes: applying a set of post-processing prompts to the plurality of candidate concepts to extract, at finer granularity, product attributes, consumer needs, occasions, or preparation methods.

In some aspects, the techniques described herein relate to a computer system, wherein training the predictive impact model includes fitting a gradient-boosted decision-tree regressor and computing SHAP values to derive the contribution value for each mapped ontology node.

In some aspects, the techniques described herein relate to a computer system, wherein the processor is further configured to: fine-tune the LLM with a training corpus of prompt-completion pairs generated from validated candidate concepts and sentiment polarities, thereby reducing inference latency and improving concept-extraction accuracy.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined and it will be readily appreciated that features described in the context of one aspect of the invention can be combined with other aspects. Aspects can be implemented in any convenient form, for example, by appropriate computer programs, which may be carried on appropriate carrier media (computer-readable media), which may be tangible carrier media (e.g., disks) or intangible carrier media (e.g., communications signals). Aspects may also be implemented using suitable apparatus, which may take the form of programmable computers running computer programs arranged to implement the aspect. As used in the specification and in the claims, the singular form of “a,” “an,” and “the” include plural referents unless the context clearly dictates otherwise.

### BRIEF DESCRIPTION OF THE DRAWINGS

FIG. 1 is a schematic illustration of an example system for generating interpretable outputs from unstructured data, according to an embodiment.

FIG. 2A is a diagram showing an example architecture of a machine-learning model pipeline for generating insights based on unstructured data, according to an embodiment.

FIG. 2B is a diagram showing an example flow diagram for generating insights based on unstructured data, according to an embodiment.

FIGS. 2C-2H show various aspects of training, evaluating, and executing the machine-learning models discussed herein, according to different embodiments.

FIG. 3 is a diagram showing an example diagram for generating insights based on unstructured data, according to an embodiment.

FIGS. 4A-4C are example user interfaces generated by the machine-learning models discussed herein, according to different embodiments.

FIGS. 5A-5B are example user interfaces generated by the machine-learning models discussed herein, according to different embodiments.

FIG. 6 is an example graph of univariate forecasting on the mentions data of an example concept or entity extracted from unstructured text data, according to an embodiment.

FIG. 7 is a flowchart illustrating a method of generating interpretable outputs from unstructured data, according to an embodiment.

FIGS. 8A-B are examples of insights generated using the methods and systems discussed herein, according to different embodiments.

FIG. 9 is a flowchart illustrating a method of generating interpretable outputs from unstructured data, according to an embodiment.

FIG. 10 is an example of insights generated using the methods and systems discussed herein, according to different embodiments.

### DETAILED DESCRIPTION

Non-limiting examples of various aspects and variations of the embodiments are described herein and illustrated in the accompanying drawings.

One or more embodiments described herein generally relate to systems and methods for generating insights based on unstructured product review data. The processes used to generate said insights can be implemented using one or more machine-learning models, which may operate in a machine-learning pipeline. The machine-learning models can be trained according to the various training processes described herein. The machine-learning pipeline can be implemented using a variety of natural language processing models, which may be utilized to both extract entities, topics, or categories from unstructured text, to assign tags and sentiment values to the extracted entities, topics, or categories, and to identify relationships between the tagged entities based on the unstructured text data.

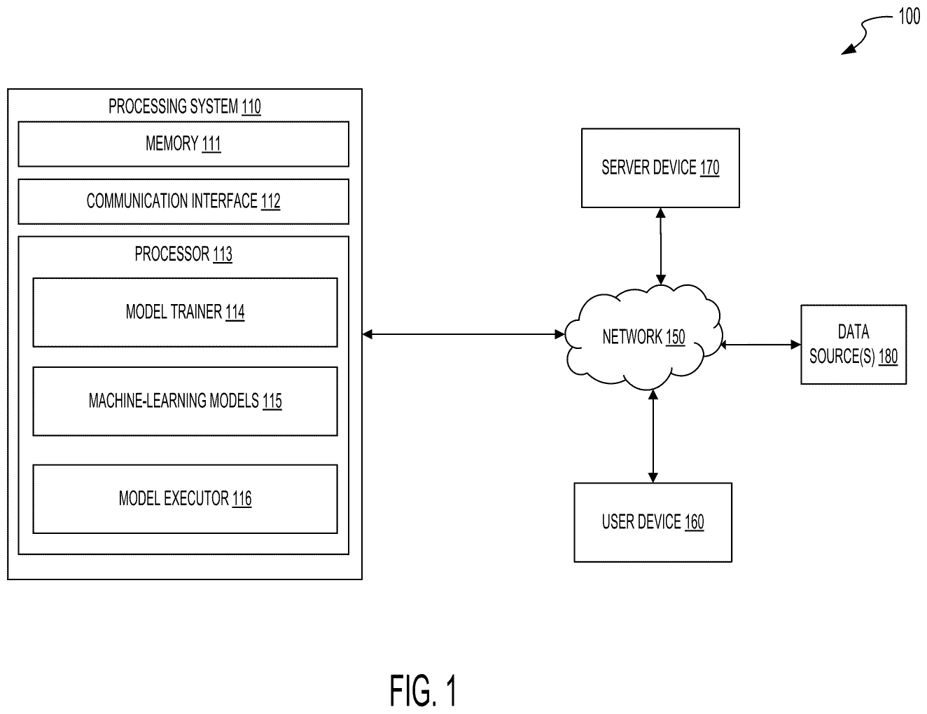

FIG. 1 is a schematic illustration of an example system 100 for generating insights based on any corpus of text (e.g., unstructured product review data), according to an embodiment. Even though aspects of the methods and components are described in the context of product reviews, it is expressly understood that the methods and systems discussed herein apply to any text.

The system 100 can be used to extract and analyze entities in product review data, which may be retrieved from multiple data sources, such as the data source(s) 180. The data retrieved from the data sources 180 can be processed using the machine-learning model 115, which may be an LLM. Thereby, the machine-learning model 115 is sometimes referred to herein as the LLM. The system 100 can include a processing system 110, a user device 160, a server 170, and one or more data sources 180. The processing system 110, the user device 160, and/or the server 170 can be operatively coupled to each other via a network 150. The processing system 110 includes a memory 111, a communication interface 112, and a processor 113.

The memory 111 of the processing system 110 can be, for example, a memory buffer, a random access memory (RAM), a read-only memory (ROM), a hard drive, a flash drive, a secure digital (SD) memory card, a compact disk (CD), an external hard drive, an erasable programmable read-only memory (EPROM), an embedded multi-time programmable (MTP) memory, an embedded multimedia card (eMMC), universal flash storage (UFS) device, or the like. The memory 111 can store, for example, one or more software modules that include processor-executable or processor-interpretable instructions to cause the processor 113 to execute one or more processes or functions (e.g., a model trainer 114, one or more machine-learning models 115, or a model executor 116).

The communication interface 112 of the processing system 110 can include a software component (e.g., executed by processor 113), a hardware component of the processing system 110, or combinations thereof, to facilitate data communication between the processing system 110 and external devices (e.g., the user device 160, the server 170, the one or more data sources 180, other computing systems, etc.) or internal components of the processing system 110 (e.g., the memory 111 and the processor 113). The communication interface 112 can be operatively coupled to and used by the processor 113 and the memory 111. The communication interface 112 can be, for example, a network interface card (NIC), a Wi-Fi™ module, a Bluetooth® module, an optical communication module, or any other suitable wired or wireless communication interface.

The communication interface 112 can be configured to communicatively couple the processing system 110 to the network 150, as described in further detail herein. In some instances, the communication interface 112 can facilitate receiving or transmitting data via the network 150. More specifically, in some implementations, the communication interface 112 can facilitate receiving or transmitting one or more datasets, including unstructured data (e.g., text data for various product reviews), machine-learning models, or other data related to the techniques described herein, through the network 150 from/to the user device 160, the server 170, or the one or more data sources 180.

The processor 113 can be, for example, a hardware-based integrated circuit (IC) or any other suitable processing device configured to run or execute a set of instructions or a set of code. For example, the processor 113 can include a general-purpose processor, a central processing unit (CPU), an accelerated processing unit (APU), an application-specific integrated circuit (ASIC), a field-programmable gate array (FPGA), a programmable logic array (PLA), a complex programmable logic device (CPLD), a programmable logic controller (PLC), a graphics processing unit (GPU), a neural network processor (NNP), a tensor processing unit (TPU), and/or the like. The processor 113 can be operatively coupled to the memory 111 or the communication interface 112 through a system bus (for example, an address bus, a data bus, or a control bus, not shown).

The processor 113 can include a model trainer 114, one or more machine-learning models 115, and a model executor 116, each of which can include software stored in the memory 111 and executed by the processor 113. For example, code to cause the model trainer 114 to retrieve unstructured data from the one or more data sources 180, generate one or more training sets, and train the machine-learning models 115 can be stored in the memory 111 and executed by the processor 113. Alternatively or in addition, each of the model trainer 114, the one or more machine-learning models 115, or the model executor 116 can be or include a hardware-based device.

The model trainer 114 can retrieve unstructured data from the data sources 180. The data sources 180 can be any type of data source that may store text data relating to one or more items, products, product categories, merchants, or brands, among others. Some non-limiting examples of the data sources 180 can include e-commerce websites, social media websites, investor reports, and consumer interaction databases, among others. The model trainer 114 can retrieve the unstructured data, for example, to generate training sets to train the machine-learning models 115 as described herein. The model trainer 114 can include one or more web scraping components, which, when executed, can scrape reviews, product descriptions, or other text data relating to various products, items, or brands, from the data sources 180, which may include websites or content repositories that include said data. Additionally or alternatively, unstructured data may be retrieved or received from the server device 170. The server device 170 may provide information via the network 150.

In some embodiments, the processing system 110 includes a multimodal data ingestion module configured to extract, standardize, and integrate insights from both visual and structured non-textual sources alongside unstructured textual data. This module can enhance the system's ability to generate comprehensive and context-rich analytic outputs by incorporating diverse data modalities into the unified analytic model.

The multimodal ingestion pipeline may include a computer vision submodule that processes image-based inputs, such as product packaging, marketing materials, or user-uploaded photos. Using one or more convolutional neural networks (CNNs) or transformer-based vision models, the system can identify visual product attributes (e.g., color, shape, packaging type), contextual aesthetics (e.g., minimalism, luxury cues), and inferred emotional indicators (e.g., smiling faces, vibrant color palettes). These visual features may be encoded into embeddings and aligned with the system's ontology for downstream analysis.

In parallel, the system may include metadata scrapers that extract structured attributes from eCommerce Product Detail Pages (PDPs). These scrapers may be configured to parse HTML, JSON-LD, or other structured markup to retrieve product metadata such as brand, size, color, nutritional information, ingredients, certifications, and pricing. The extracted data may be normalized using a schema-matching engine and mapped to the system's internal data model.

All multimodal inputs—whether visual, structured, or textual—may be passed through automated data cleaning and standardization pipelines. These pipelines can remove noise, resolve inconsistencies, and ensure that all data is formatted for compatibility with the machine-learning models 115 and the ontology mapping components described in earlier sections. The resulting unified dataset may enable the system to perform richer and more accurate sentiment analysis, trend detection, and impact modeling. For example, the system may ingest both textual reviews and product images to identify that a particular protein bar is perceived as “clean” and “natural” not only due to its ingredient list (from PDP metadata) but also due to its white minimalist packaging (from image analysis). These multimodal signals may then be fused to generate a more robust understanding of consumer perception.

The multimodal ingestion module may be used to ingest new data types (e.g., audio, video, sensor data) without requiring fundamental changes to the core architecture. This modularity ensures that the system remains adaptable to evolving data sources and analytic requirements.

In some embodiments, the processing system 110 includes an intent and emotion inference module configured to augment traditional sentiment analysis by identifying latent user intent and emotional tone from linguistic patterns in unstructured text. This module may enhance the interpretability and depth of the system's outputs by moving beyond polarity-based sentiment scoring (e.g., positive, negative, neutral) to infer more nuanced emotional states and behavioral signals.

The intent and emotion inference module may operate by analyzing syntactic, semantic, and contextual features of the input text, including but not limited to word choice, sentence structure, punctuation, repetition, and metaphorical language. These features may be processed using a combination of rule-based heuristics and machine-learned classifiers trained on annotated corpora of emotional expression. The system may also leverage pretrained emotion embeddings or transformer-based models fine-tuned for affective computing tasks. For example, a review stating “I've tried everything and nothing worked—until now” may be classified as expressing relief and hope, even if the explicit sentiment score is neutral. Similarly, a phrase such as “I wouldn't wish this experience on anyone” may be flagged as expressing frustration or betrayal, despite lacking overtly negative keywords.

The inferred emotional indicators may be mapped to a predefined emotion ontology (e.g., joy, trust, anger, fear, surprise, sadness, anticipation, disgust) and stored alongside the sentiment values in the system's data structures. These emotion tags can be used to enrich downstream analytics, such as identifying emotionally resonant product features, segmenting audiences by affective profile, or detecting shifts in consumer mood over time. In one embodiment, the system uses these emotion signals to refine impact modeling and trend forecasting. For instance, a spike in “anxiety” or “urgency” associated with a product category may indicate an emerging consumer concern, prompting proactive intervention or messaging adjustments.

After retrieving the unstructured data from the data sources 180, the model trainer 114 can extract product descriptions from the unstructured data. The model trainer 114 can generate and store the product descriptions in a data structure for each product review in the unstructured data. This effectively generates structured data from the unstructured data. To do so, the model trainer 114 can execute various pattern matching (e.g., regular expression matching) or other website-specific extraction rules to generate the data structure for each product review. This process may be referred to as “cleaning” the scraped data, which includes converting the unstructured data, which may be retrieved from multiple sources, into a standard format (e.g., a standard data structure that may be utilized by the techniques described herein). The generated data structures can then be used in further processing. An example representation of a data structure for a product review generated from the unstructured data is shown in Table 1 below.

TABLE 1

| Review | Review | | | | | Product |
|---|---|---|---|---|---|---|
| ID | Text | Date | Product | Brand | Ratings | Description |
| 1 | This mattress | Jan. 1, 2023 | Tempur- | Tempur- | 5 | Tempur-Pedic |
| | is super | | Pedic | Pedic | | Breeze is an |
| | comfortable | | Breeze | | | 11-inch Memory |
| | for me to use | | | | | foam mattress |
| | | | | | | that is super |
| | | | | | | comfortable. |

Upon generating data structures similar to the data structure represented in Table 1, the model trainer 114 can generate a training dataset by assigning one or more tags to each product review. After the machine-learning model 115 has been trained, various user interfaces (UIs) can be generated and displayed on the user device 160 and/or other computing devices.

Using the methods and systems discussed herein can allow one or more processors, such as the processing system 110 to leverage LLMs to capture more information for a given concept with more breadth and more depth. As discussed herein, the methods and systems discussed herein can be applied to any structure or unstructured body of text, such as item reviews inputted by one or more users. Using the modeling technique may lead to an increase in information capture and an increase in the reviews tagged under moments and audiences. In order to train the LLM (machine-learning model 115), the processing system 110 may use various methods and pipelines.

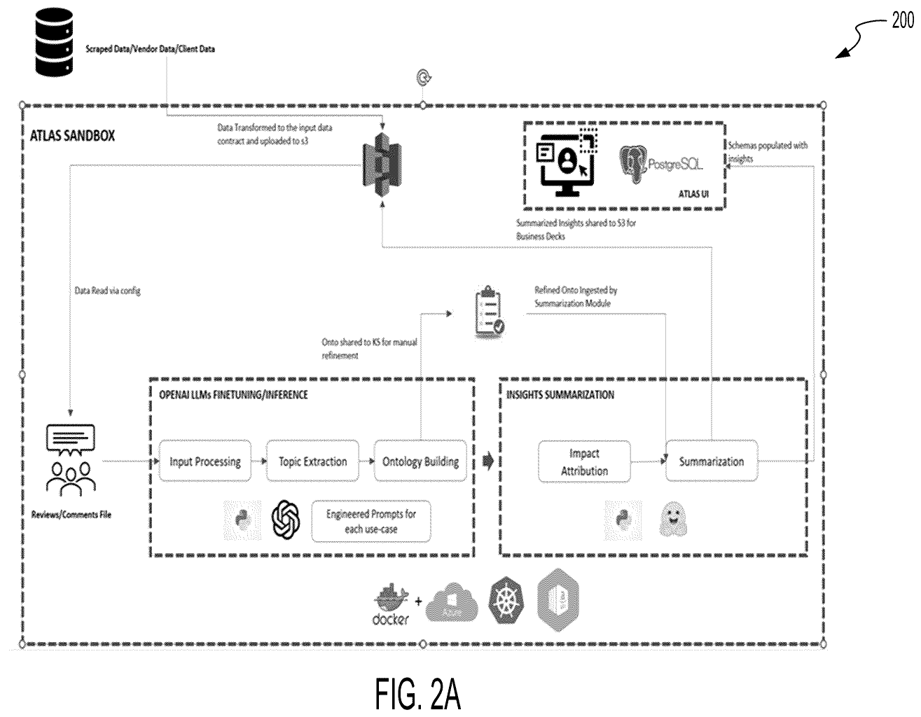

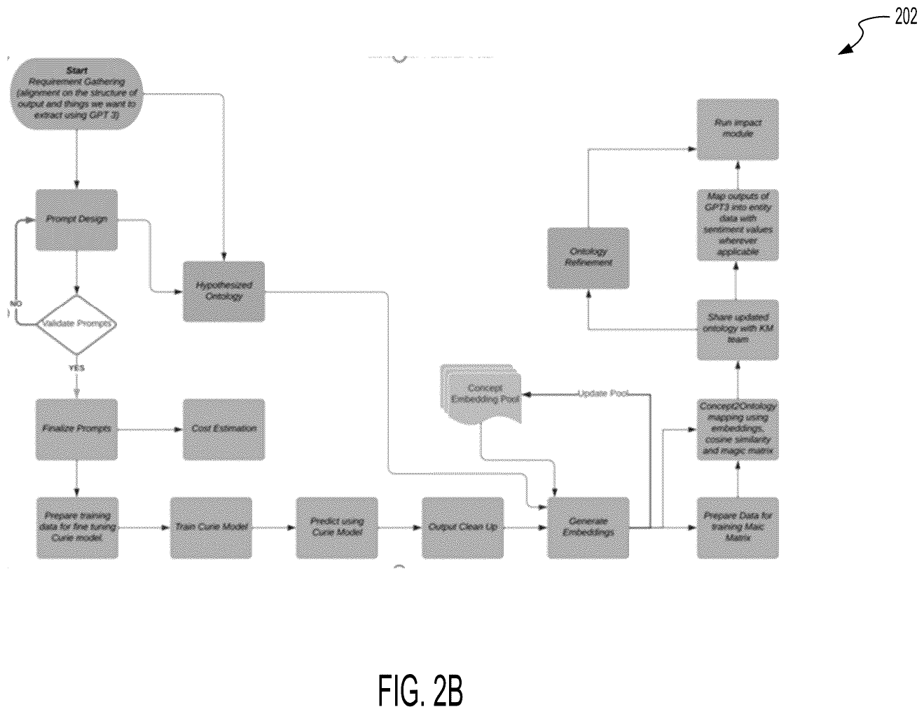

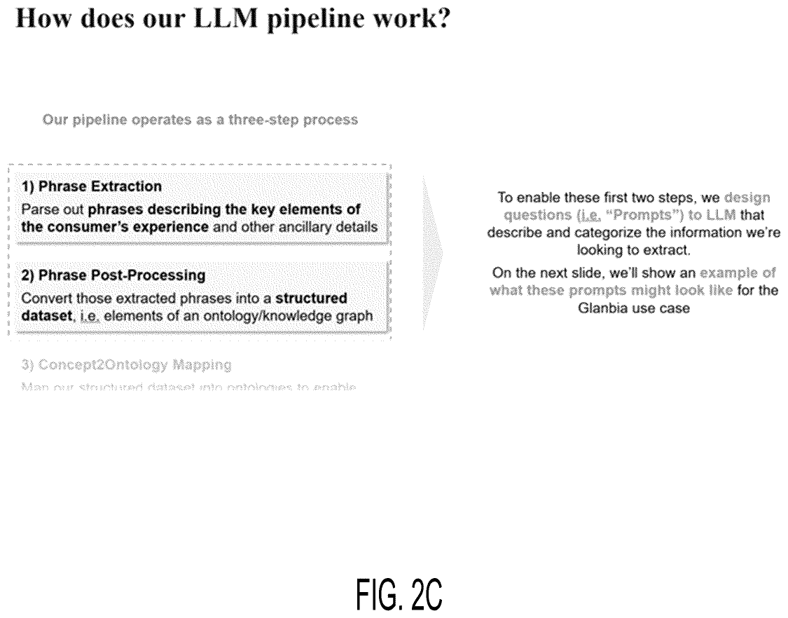

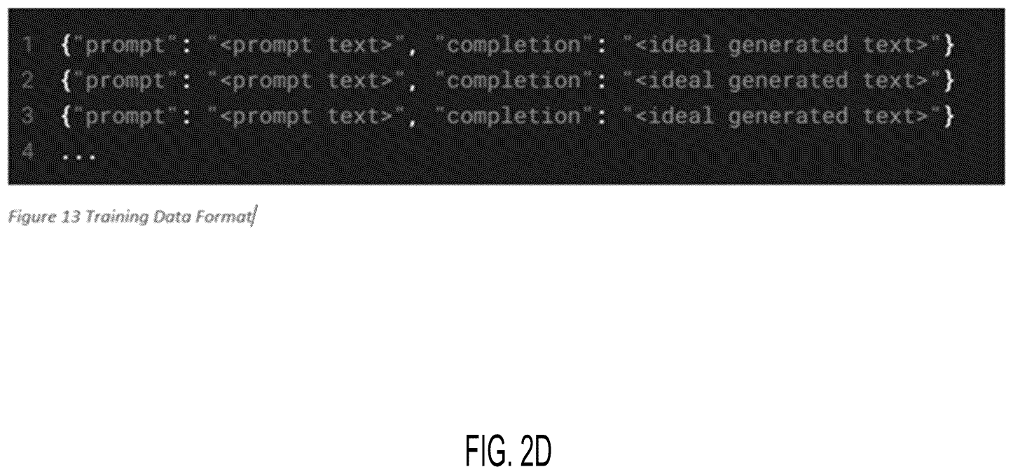

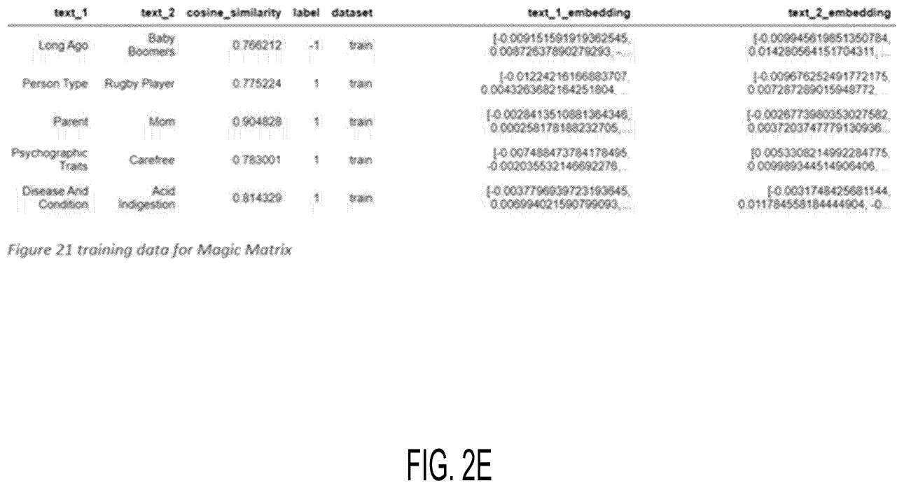

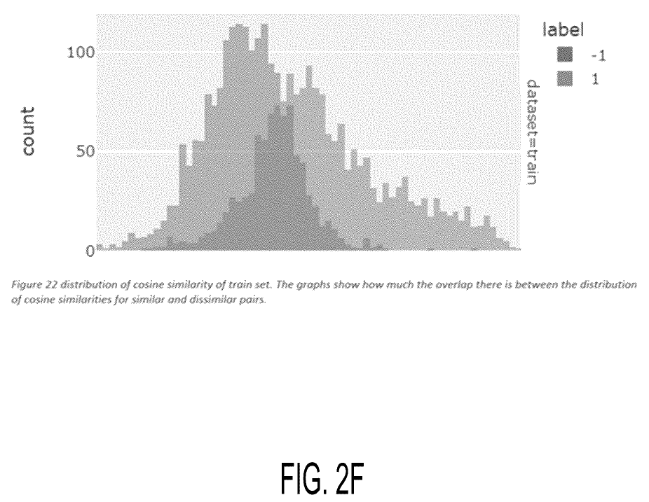

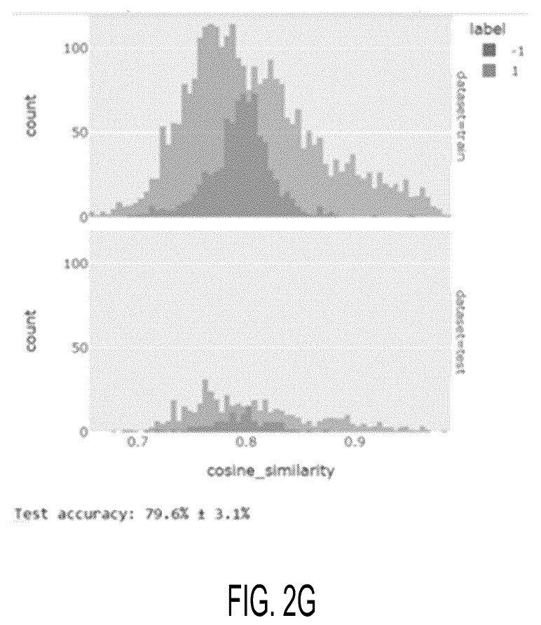

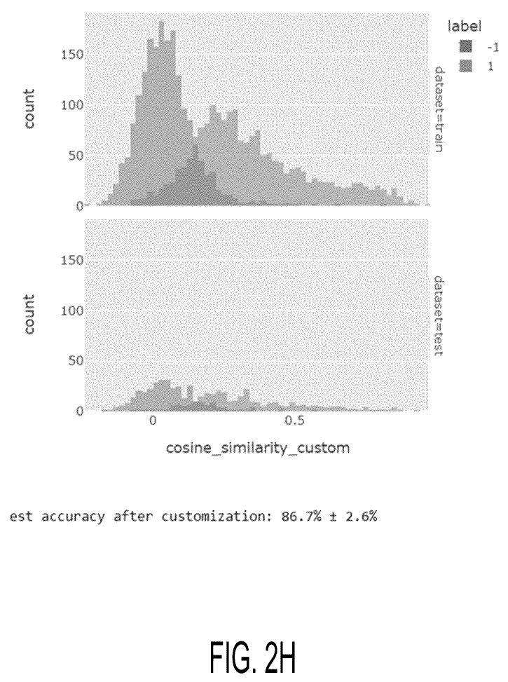

Referring now to FIG. 2A, a system 200 represents an exemplary diagram of how the methods and systems discussed herein can be implemented. The system 200 may be an LLM-based pipeline that may contain the following units of functionalities:
A. Requirements Gathering
B. Prompt Design
C. Prompt Validation
D. Hypothesized Ontology
E. Cost Estimation
F. Prediction-Prepare training data
G. Fine-Tuning
H. Inference Using Fine-Tuned Model
I. Generate Embeddings
J. Train Magic Matrix
K. Concept to Ontology Mapping
L. Ontology Refinement
M. Impact Calculation

Each of the steps is described herein. Moreover, the pipeline 202 (depicted in FIG. 2B) illustrates how these components can be executed to achieve the results discussed herein.

### A. Requirement Gathering:

Before executing the methods discussed herein (e.g., running the pipelines discussed herein), the processing system 110 may need to understand the business problem being solved. This information may be used for designing prompts and/or using the information in downstream processes. During this phase, the processing system 110 may ingest answers to the following questions provided as non-limiting examples:
What are the key dimensions needed to place the phrases in? (e.g., Occasions, Purchase Process, etc.)
What are the key dimensions for which the sentiment is needed? (e.g., Product Features, Consumer Needs, etc.)
Across what dimensions should the impact calculation be calculated? (e.g., Product Features, Consumer Needs, etc.)
What is the expected output.

The processing system 110 may host and display a platform having various input elements configured to receive one or more inputs from an end user. For instance, the processing system 110 may display the platform on the user device 160.

Input Data Description—The processing system 110 uses two primary open-source datasets as input: the Review Dataset (customer feedback) and the Product Information Dataset. These datasets collectively empower the processing system 110 to dynamically evolve and deliver unparalleled user experiences.

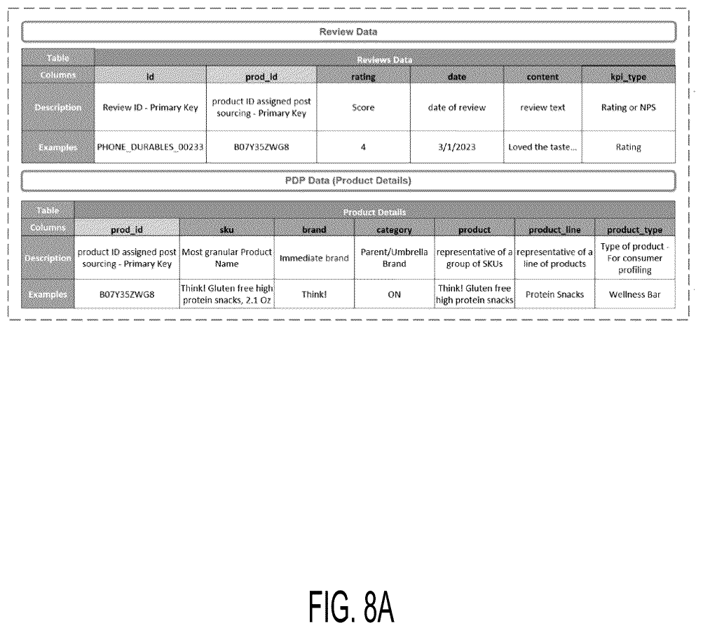

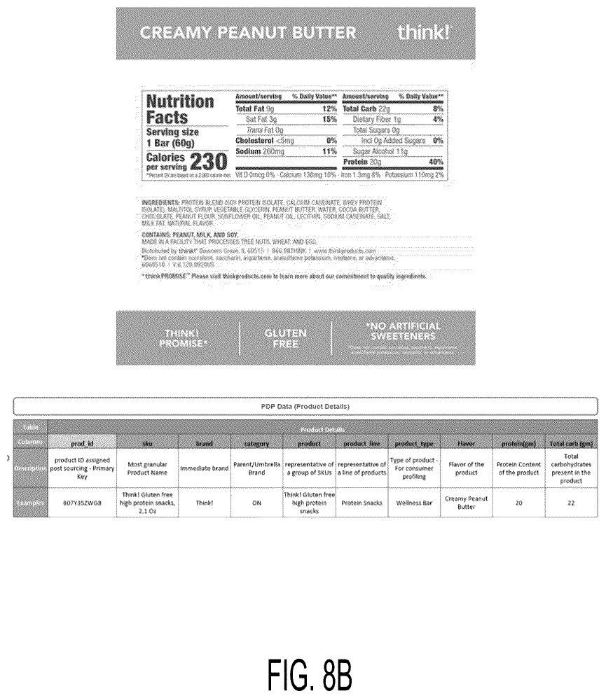

The Review Dataset encapsulates unstructured customer feedback, seamlessly blending the qualitative insights of user experiences with the quantitative metric of user ratings. This amalgamation of sentiments and numerical assessments equips our system with a rich understanding of customer satisfaction, pain points, and preferences (e.g., FIG. 8A).

The Product Information Dataset complements the Review Dataset by providing structured details about each product, including brand, category, and other relevant attributes. This contextual information establishes a link between customer feedback and the specific characteristics of the products involved (e.g., FIG. 8A).

Moreover, the Product Information Dataset extends its scope to include valuable insights derived from product images, capturing attributes like flavor and nutritional content. The utilization of product images as a data source is a pivotal element in our data strategy. Cutting-edge image processing techniques are employed to extract granular details such as flavor and nutritional content, enhancing our ability to decipher intricate product nuances. FIG. 8B shows an example of image data usage for Food & Beverage category—the product dataset is updated with Flavor, Protein and Total Carbs extracted from the image. By intertwining the Review Dataset with the Product Information Dataset, processing system 110 can discern patterns such as specific product lines receiving higher praise or common issues across a particular category. This contextualization enhances the precision of data analysis, enabling targeted enhancements and strategic decision-making.

In some embodiments, the system is configured to support multi-lingual processing, enabling the extraction of semantically equivalent concepts, sentiment values, and ontology mappings from unstructured text inputs authored in non-English languages. This capability allows the underlying large language models and associated pipelines to operate across diverse linguistic corpora without requiring substantial modifications to the core architecture. For example, user reviews, survey responses, or social media comments written in languages such as Spanish, French, or Mandarin can be analyzed using language-specific prompts, tokenization schemes, and embedding models aligned to the same semantic ontology used for English inputs. This multilingual interoperability enables consistent insight generation, sentiment attribution, and impact modeling across global datasets, thereby supporting cross-market analysis and scalable international deployments.

### B. Prompts Design:

In this phase, the processing system 110 may perform a prompt-based phrase extraction using the LLM. This prompt-based phrase extraction may be implemented in lieu of a Pytorch-based flair entity extraction in which (traditionally after entity extraction), the processing system 110 performs entity merging to capture phrases. In contrast to conventional/traditional methods, the prompt-based phrase extraction using LLM results in a reduction of the created noise.

As used herein, a prompt may refer to a question or instruction ingested by the LLM. For instance, a prompt may be a question that can be asked from an LLM. The prompt may be designed based on the different types of information expected to be returned from the LLM (e.g., the user may desire to capture/extract certain information out of a body of text (e.g., item reviews) and may desire to answer certain questions using the extracted information). Based on the prompt, the LLM may extract the information, summarize the content, and provide an answer to the asked questions based on the descriptive definition of each prompt provided.

In some embodiments, the LLM may be pre-trained and/or partially trained. For instance, the LLM may be acquired from a third-party source and fine-tuned (customized), such that it can perform the features discussed herein. Therefore, identifying and generating a correct set of prompts may be needed to achieve accurate results efficiently.

Referring now to FIG. 2C, an exemplary flow diagram of the operations performed by an LLM is depicted. As depicted, in some embodiments, there may be two broad categories of prompts that can be designed to extract information from texts using LLM.

The first category (also known as the phrase extraction prompts) may refer to prompts used for capturing most of the required information at a broad level, such as positive/negative/neutral phrases, consumer needs, occasions, consumer characteristics, and the like.

The second category (also known as post-processing prompts) may refer to prompts used to capture granular information by running prompts on the phrases extracted in the first step. For example, these prompts may instruct the LLM to capture product attributes and their perception from positive/negative/neutral phrases. Also, these prompts can be used to categorize the extracted phrases into broader categorical buckets, such as categorizing occasions into eight broad buckets. These buckets may be pre-defined and pre-determined.

In some embodiments, the processor may use the following prompt for information extraction:
Using the following format, analyze the following product review. Use the information only from the review. If relevant information cannot be found, write “N/A”.
Positives: <Bulleted list of things perceived positively by the reviewer about the product (e.g., taste, texture)>
Negatives: <Bulleted list of things perceived negatively by the reviewer about the product (e.g., taste, texture)>
Neutrals: <Bulleted list of things perceived neither positively nor negatively by the reviewer about the product (e.g., package size, price)>
Occasions: <Bulleted list of contexts in which the product is being consumed (e.g., post-workout, post-surgery, on the go, while traveling)>
Preparation Method: <Bulleted list of how the product was used to prepare a dish by the reviewer (e.g. mixing in a smoothie, adding it to coffee, baking with the product)>
Consumer Needs: <Bulleted list of functional or emotional drivers for consuming the product (e.g. weight loss, building muscle, recovery from a workout)>
Time of Day: <Bulleted list of the time of the day or the meal during which the product was consumed (e.g., Before breakfast, in the afternoon, as an evening snack)>
Consumer Attributes: <Bulleted list of attributes that describe the reviewer or other consumers (e.g., demographics)>
Recommendations: <Bulleted list of recommendations the reviewer provides on whether they or others should buy the product (e.g., don't recommend, great for coffee lovers)>
Purchase Process: <Bulleted list of how the reviewer purchased or made the decision to purchase the product (e.g., read reviews, bought in bulk)>

The LLM may then ingest the following text (in this non-limiting example a review provided by a consumer):
Mixed well in both hot and cold liquids. mostly tasteless in water, completely tasteless in smoothies or coffee. (It worked best for me mixed in a morning smoothie). I've been taking it daily for about a week and noticed a slight increase in energy, clearer skin, and mind, and craved fewer sweets as well! I am recovering from dental surgery and I'm sure this is aiding in that recovery #hometesterclubfreesample.

After analyzing the text, the LLM may output the following data (e.g., buckets of information):
Positives:
   Mixed well in both hot and cold liquids
   Slight increase in energy
   Cleared the skin
   Cleared the mind
   Reduced craving for sweets
Negatives:
   N/A
Neutrals:
   Mostly tasteless in water
   Completely tasteless in smoothies or coffee
Occasions:
   Daily
   Recovering from dental surgery
Preparation Method:
   Mixed in the morning smoothie
   Mixed in hot and cold liquids
   Mixed in water.
   Mixed in coffee
Consumer Needs:
   Increase energy
   Aid in recovery
Time of Day:
   Morning
Consumer Attributes:
   Home tester
Recommendations:
   N/A
Purchase Process:
   Free sample

As illustrated herein, the buckets included within the sample/example output may correspond to the buckets defined by the end user within the prompt.

### Post-Processing Prompts:

The processing system 110 may also evaluate the prompts and the results. For instance, evaluating text using the prompts (e.g., the prompts discussed above) may result in the identification of different product attributes and perceptions. In a non-limiting example, the prompt may include the following language:
each phrase summarizes an experience from the corresponding product review. Using the following format, analyze the following phrase. Use the information only from the phrase and review.
If relevant information cannot be found, write “N/A”.
Product Feature: <the product feature is described by the reviewer (e.g., Taste, Mixability, Energy Boosting Ability)>
Perception: <the reviewer's perception of the product (e.g., Nasty, Easy, Effective)>

Then the LLM may analyze the following item review:
Mixed well in both hot and cold liquids. mostly tasteless in water, completely tasteless in smoothies or coffee. (It worked best for me mixed in a morning smoothie). i've been taking it daily for about a week and noticed a slight increase in energy, clearer skin, and mind, and craved fewer sweets as well! I am recovering from dental surgery and i'm sure this is aiding in that recovery #hometesterclubfreesample.

The LLM may identify the phrase “mixed well in both hot and cold liquids” and may determine that the product has a feature of “bendability” and the perception of the customer who left the review is “good.”

In another example, the same item review can be reviewed using the following prompt:
Demand Moment: <The category to which the phrase should be tagged out of the following categories: (Stay in Shape or Tone Up, Lose Weight, Intense Training, Gain Strength and Muscle, Improve Beauty or Appearance, Improve General Health and well-being, Reduce Pain, Recover After A Workout, Gain Energy, Recover From A Surgery Or Illness)>

As a result, the LLM may determine the phrase to be “cleared the skin” and sentiment as “improve beauty or appearance.”

In a non-limiting example, the model executor 116 can provide sentences or phrases from scraped product reviews and/or the extracted entities to generate respective sentiment values for each extracted entity in each product review. Sentiment values may be generated for entities. Executing the LLM can include providing the text data from the product reviews (and/or the entities extracted from the product reviews) as input and propagating the input through the LLM. The model executor 116 can repeat this process for each scraped review of each product, brand, market, product category, data source, or other user-specified criteria to generate sentiment values for each entity identified in each review. Example input and output data structures that may be provided in part to or generated in part by the LLM are represented below:

TABLE 2
(Input, prior to generation of sentiment values)

| Review ID | Entity | Concept |
|---|---|---|
| 1 | Odor | Smell |
| 1 | Comfort | Comfortable |
| 1 | Back | Pain Relief |
| 1 | Back Pain | Pain Relief |
| 1 | Amazing | Amazing |

TABLE 3
(Output, after generating sentiment values)

| Review ID | Entity | Concept | Sentiment Value |
|---|---|---|---|
| 1 | Odor | Smell | −1 |
| 1 | Comfort | Comfortable | 1 |
| 1 | Back | Pain Relief | 1 |
| 1 | Pain | Pain Relief | 1 |
| 1 | Amazing | Amazing | 1 |

The sentiment values generated by the LLM can be stored in association with each respective product review, which may be used by the processing system 110 to generate a user-readable interface. The user interface may include one or more product reviews, may identify recurring entities or concepts that frequently appear in the product reviews, and may show information relating to the sentiment associated with each extracted entity.

### C. Prompt Validation:

The processing system 110 may perform prompt engineering and validation as well. Prompt engineering, as used herein, may refer to an iterative process where different prompts are evaluated to determine whether the LLM produces the desired results. Accordingly, the processing system 110 may execute the LLM using the prompts on a small subset of the text/corpus (e.g., 20 reviews). The processing system 110 may then validate and align the actual output against the expected outputs. If any issue is observed, the processing system 110 may iteratively revise the prompt and re-execute the LLM.

### E. Cost Estimation:

In some embodiments, before executing the LLM, the processing system 110 may retrieve an approximate estimate of the cost of executing the LLM. In some embodiments, the LLM may be hosted or otherwise operated by a third party, which may require their fees. In some embodiments, the cost may be dependent on the number of tokens in prompt instructions, the number of tokens in a few shots examples, the number of tokens in review and/or phrase to process, the number of completion tokens, different types of cost incurred, minimal cost during prompt designing and validation, the cost for fine-tuning any models, cost for exploding concepts (e.g. I liked chocolate and vanilla flavor->I liked chocolate flavor; I liked vanilla flavor), and/or cost for generating concept embeddings.

In some embodiments, if the cost estimation is more than a threshold, a warning note may be transmitted to a system administrator where additional approval may be needed before proceeding with performing any of the functions discussed herein.

In some embodiments, the processing system 110 includes a token optimization module configured to manage and reduce the token footprint of prompts and responses processed by the LLM, particularly in scenarios where strict token budgets are enforced. This module may enable the system to maintain high-quality inference while minimizing latency and computational cost. The token optimization process may include a negotiation phase, wherein the system dynamically rewrites or restructures prompts to reduce token count without materially degrading semantic meaning. This may involve rephrasing verbose instructions, collapsing redundant clauses, or substituting predefined macros for common prompt patterns. The system may also apply compression techniques to the response space, such as truncating low-value completions or summarizing intermediate outputs.

In addition to prompt rewriting, the processing system 110 may implement a technique referred to as “lossy token sketching.” In this approach, certain segments of a prompt or response—particularly those that are semantically stable or previously inferred—may be replaced with compact representations such as embedding vectors, hashed identifiers, or symbolic placeholders. These representations may be selected to be “close enough” in semantic space to the original content, such that the LLM can continue inference with minimal degradation in output quality. For example, a frequently used product description or ontology node may be replaced with a hashed embedding that the model has been fine-tuned to interpret equivalently.

The token optimization module may operate in conjunction with the adaptive caching system described herein. For instance, if a prompt segment has been previously processed and its embedding is cached, the system may substitute the cached embedding directly into the prompt, thereby avoiding re-tokenization and reducing the overall token count. This optimization may be particularly beneficial in high-throughput environments or when processing large volumes of unstructured data, such as millions of product reviews or customer feedback entries. It may also support scenarios where prompt length is constrained by model architecture or API limitations. By reducing token usage without sacrificing interpretability or accuracy, the system can achieve improved scalability and cost-efficiency.

### F. Prediction Training Data:

After the prompts are validated and finalized, the processing system 110 may use the prompts to predict various text corpora, e.g., item reviews for phrase extraction and phrases (not reviews) for each of the post-processing prompts. This data can be used to fine-tune one or more models. The processor may generate an API key and ensure that the API key is appropriately linked with the proper project code for billing (and use the same API key for the entire project).

### G. Fine-Tuning

Fine-tuning may be used to increase the insights received from the LLM. For instance, the processing system 110 may train the LLM on one or more examples than can fit in a prompt, shorten the prompt length (this can be used to reduce the cost associated with executing the LLM), and/or lower the latency associated with executing the LLM.

The LLM may have been trained or pre-trained using a vast amount of text from various sources, such as the open and publicly accessible Internet. In some embodiments, when given a prompt with just a few examples, the LLM may intuit what task to be performed and may generate a plausible completion. This is sometimes referred to as “few-shot learning.” The processing system 110 may fine-tune the LLM for its intended purpose to improve its performance. Fine-tuning may improve few-shot learning by training on many more examples than can fit in the prompt, letting the LLM provide better results and allowing the user to achieve better results on a wide number of tasks. Once the LLM has been fine-tuned, the administrator or the user may no longer need to provide examples in the prompt. Accordingly, fine-tuning may save costs and may enable lower-latency requests.

In some embodiments, fine-tuning may involve various steps performed by the processing system 110 and/or a third party under the direction of the processing system 110. For instance, the processing system 110 may first prepare and upload training data, train a new fine-tuned model, and use the fine-tuned model.

### Prepare Training Data

The processing system 110 may first prepare training data to train the LLM. Using the training data, the LLM may be trained, such that the LLM can uncover hidden patterns within various corpus of texts analyzed. In some embodiments, the data included within the training data may be included within JSONL documents/files, where each line is a prompt-completion pair corresponding to a training example (as depicted in FIG. 2D). In some embodiments, a data preparation tool may be used to convert data (e.g., data retrieved from various sources) into this file format. Before preparing the training data, the processing system 110 may retrieve raw data from various sources that can be refined into a format that can be ingested by the LLM to produce results (for fine-tuning purposes).

It should be noted that designing prompts and completions for fine-tuning may be different from designing prompts for use with the base models (LLM before it is fine-tuned). In some embodiments, while prompts for base models often consist of multiple examples (e.g., “few-shot learning”), for fine-tuning, each training example generally consists of a single input example and its associated output, without the need to give detailed instructions or include multiple examples in the same prompt.

In some embodiments, the processor may use one or more tools to validate, provide suggestions, and/or reformat the data retrieved. The tool may accept different formats, with the only requirement that they contain a prompt and a completion column/key. Using the tool, the processing system 110 may use a CSV, TSV, XLSX, JSON, or JSONL file, and the tool may save the output into a JSONL file ready to be ingested by the model for fine-tuning.

Using the training data prepared (as discussed herein), the processing system 110 may further train the LLM. The processing system 110 may use various commands to upload the files (within the training data), such as by using one or more APIs. The processing system 110 may then create one or more fine-tuning jobs. Subsequently, the LLM may then be fine-tuned by ingesting the provided data.

After the LLM has been fine-tuned, the processing system 110 may evaluate the results. This can be done by predicting a sample of reviews and phrases and getting the input and output pair validated by a reviewer (whether algorithmic or human reviewer).

### H. Inference Using Fine-Tuned Model:

Once the Language Model (LLM) has undergone the process of fine-tuning, the refined model is ready for deployment in the processing system 110, unlocking a myriad of benefits in terms of increased insights, cost reduction, and lowered latency. The fine-tuned LLM, having been trained on a broader spectrum of examples than can fit in a prompt, exhibits enhanced performance, enabling the processing system to derive superior results. The culmination of the fine-tuning process facilitates the efficient inference of the fine-tuned model on the entire data set.

### I. Generate Embeddings:

Embeddings, as used herein, may refer to numerical representations of concepts converted to number sequences. In some embodiments, embeddings may generate efficiencies with respect to the LLMs understanding the relationships between those concepts. Embeddings that are numerically similar may also be semantically similar. For example, the embedding vector of “canine companions say” may be more similar to the embedding vector of “woof” than that of “meow.”

The processing system 110 may use embeddings to place concepts extracted from LLM into a hypothesized ontology based on embedding/semantic similarity. In some embodiments, for all distinct concepts in the hypothesized ontology and from phrase post-processing outputs, the processing system 110 may generate a table with all distinct concepts. The processing system 110 may then standardize these in various manners before getting to the distinct set, for instance, by converting all to title cases and/or splitting on “/”, commas, “and”, “or.”

In some embodiments, the processing system 110 includes an ontology construction and refinement module configured to generate, expand, and maintain a hierarchical concept ontology using embeddings derived from the LLMs. This ontology construction and refinement module may enable the system to organize extracted concepts into a structured semantic framework that supports downstream tasks such as sentiment aggregation, impact modeling, and user interface presentation. A hypothesized ontology may be initially constructed using domain-specific seed concepts or imported taxonomies. The system then uses LLM-generated embeddings to populate and refine this ontology. Each concept extracted from unstructured data—such as product reviews, survey responses, or social media posts—may be encoded into a high-dimensional vector using a pretrained or fine-tuned LLM. These embeddings may capture semantic similarity between concepts, enabling the system to cluster related terms and identify hierarchical relationships.

The system may support unsupervised clustering of concepts using techniques such as k-means, DBSCAN, or hierarchical agglomerative clustering. These clusters are used to propose new branches or refinements to the existing ontology. Additionally, a customized embedding transformation matrix—referred to herein as the “Magic Matrix”—may be applied to align the embedding space with the ontology's structural constraints. This matrix may be trained using labeled node pairs and optimized to emphasize dimensions relevant to the domain. In some embodiments, concepts that are not initially mapped to the ontology may be algorithmically slotted into appropriate positions using cosine similarity (or other paradigms) to existing parent nodes. For example, if a new phrase such as “gut-friendly” is extracted from a review, and its embedding is most similar to the node “digestive health” under the “Consumer Needs” dimension, the system will place it as a child of that node.

In some implementations, to improve human interpretability and support collaborative refinement, the system's user interface may include dynamic quote surfacing and top-phrase visibility. For each concept in the ontology, the UI may display representative quotes from the source data and highlights the most frequently associated phrases. This allows users to validate the context and appropriateness of each concept's placement within the hierarchy.

The processing system 110 may use the LLM-based few-shot prompt to optimize dependency parsing. The processing system 110 may then obtain embeddings using an embedding model teaching to identify text-similarity-based pre-trained models and generate/save the metadata file. Before running the embedding model, the processing system 110 may check if the concept already has embeddings saved in the embedding pool. In this way, the processing system 110 may only run the embedding model on the remaining concepts. Thereby, by creating and updating an embedding pool, the processing system 110 may reduce the new embeddings created.

### J. Training Magic Matrix:

The processing system 110 may customize the embeddings. In this way, the embeddings may better emphasize aspects of the text relevant to the end-users request, as depicted in FIG. 2E. In this embodiment, the input may be the training data in the form of [text_1, text_2, cosine score, label] where the label is +1 if the pairs are similar and −1 if the pairs are dissimilar.

In some embodiments, the processing system 110 may enhance the training of the Magic Matrix by supporting a variety of similarity metrics beyond cosine similarity. While cosine similarity can be used to measure the angular distance between embedding vectors, the system 110 may alternatively or additionally employ a proprietary ensemble of similarity scoring functions to capture more nuanced semantic relationships between concepts. These alternative metrics may include, but are not limited to, multivariate distance measures (e.g., Mahalanobis distance, Euclidean distance with learned feature weighting), probabilistic similarity scores, and context-aware alignment functions that incorporate co-occurrence frequency, syntactic role, and ontology depth. The ensemble approach allows the system to dynamically weight and combine these metrics based on the domain, data density, and concept type.

### Positive and Negative Node-Pair Generation Using Hypothesized Ontology

Using hypothesized ontology, the processing system 110 may generate all node pairs to be used as positive samples. The processing system 110 may start by filtering the L0 dimension to contain only relevant attributes. The relevant Node Pairs may then be extracted using levels—L1, L2, L3, L4 and L5. The processing system 110 may create pairs across all combinations of levels i.e., L1-L2, L1-L3, L1-L4, L1-L5. Subsequently, standardization may be applied across node pairs by converting all to title cases and deduplicated across node pairs. This may ensure that only 1 copy of similar combinations like (a, b) and (b, a) exists. This may be done to have reasonably sized node pairs while keeping the noise to a minimum.

For Negative pairs, the processing system 110 may start by shuffling the similar node pairs using nC2 combinations and then selecting a sample equivalent to the same number of similar node pairs. Before sampling, the processing system 110 may ensure that none of the pairs from similar node pairs are part of the nC2 combinations to have completely distinct similar and dissimilar node pair sets.

The processing system 110 may then save the outputs for both similar and dissimilar node pairs along with their cosine scores to be used for later stages during training for Magic Matrix (e.g., for custom embeddings), as depicted in FIG. 2F.

Based on the training data, the matrix may be optimized. An example of a before and after optimization plot is provided in FIGS. 2G-H where FIG. 2G represents the plot before optimization and FIG. 2H represents the plot after optimization.

### K. Concept2Ontology Mapping

For concepts that are extracted by LLM not present in the hypothesized ontology, the processing system 110 may place those concepts in the ontology based on similarity. This may be performed, such that each concept is placed in some place of the ontology. In order to achieve this, the processing system 110 may load the hypothesized ontology and final output from phrase post-processing. The processing system 110 may then evaluate phrase post-processing data by melting at dimension and Leaf Node level and then deduplicating/applying the similar standardization (as in the preceding analysis described herein) to generate unique concepts at the dimension level. Then using the embedding metadata (e.g., pre-saved), the processing system 110 may map the embeddings for both phrase processing distinct concepts and hypothesized ontology. The vectorized embeddings may then be multiplied by the magic matrix embedding (matrix optimized used to weight to compute the cosine scores. Then, for each level, cosine may be calculated and then based on max similarity assign as a child.

Therefore, in some embodiments, the inputs may be concepts extracted by the LLM, hypothesized ontology, and/or magic matrix (e.g., optimized in the previous step). The processing system 110 may then find Similar Nodes in the existing ontology. The similarity of a concept may be checked inside the L0 (corresponding to the dimension it was extracted by LLM). For example, if a concept ‘X’ was extracted by LLM under both “Consumer Needs” and “Product Features,” the processing system 110 may review/evaluate the most similar concept inside “Consumer Needs” and place it under appropriate parent and then again it will look at the most similar concept inside “Product Features” and place it under the appropriate parent.

### L. Otology Refinement

Using the methods discussed herein, the ontology may be refined. The objective of refining the ontology may be to ensure that the most prevalent concepts are not placed under some wrong/dissimilar bucket.

### LLM Output to Entity Data Mapping:

To run impact on LLM outputs, the output of LLM may be mapped into the format expected by an impact module. In some embodiments, the LLM output is mapped to existing entity data format using product feature(s) (e.g., concept), phrase (e.g., entity), and/or sentiment. For mapping the sentiment, the processing system 110 may use various pre-determined rules and logic. Non-limiting examples of logic may include:
a. If the concept was extracted from Positive phrase post-processing->1
b. If the concept was extracted from Negative phrase post-processing->−1
c. If the concept was extracted from Neutral phrase post-processing->0

In some embodiments, the ontology refinement module of the processing system 110 supports both supervised and unsupervised learning mechanisms for ontology development. This may include automated ontology generation and refinement using embeddings derived from pre-trained LLMs, enabling the system to dynamically evolve its conceptual structure in response to new data and linguistic patterns. In some embodiments, the system performs synonym consolidation by identifying and merging semantically equivalent or closely related nodes. For example, if the system encounters the concepts “grape taste” and “grape flavor” in different parts of the corpus, it will compute their embedding similarity and, if above a defined threshold, unify them under a single canonical node. This reduces redundancy and improves the consistency of downstream analytics.

The system may also support node type differentiation, distinguishing between object-type concepts (e.g., “truck,” “car”) and property-type concepts (e.g., “slow,” “fast”). This may be achieved by analyzing the grammatical role and syntactic context of each term using dependency parsing and part-of-speech tagging. The resulting classification informs the placement of nodes within the ontology's structural hierarchy.

In addition, the system may perform entity-property pair extraction by parsing noun-adjective and subject-verb-object structures. For instance, the phrase “slow car” may be decomposed into the object “car” and the property “slow,” which are then aligned as a semantically meaningful pair. These pairings are used to enrich the ontology with contextual relationships between entities and their attributes.

The system may further enhance concept definition through experience mapping, wherein verb phrases may be associated with their corresponding objects. For example, the phrase “walk to the store” can be mapped to the object “store” with an experiential context of “walking,” while “the store is clean” can be mapped to the same object with a descriptive property. This allows the ontology to capture both functional and perceptual dimensions of a concept. To maintain the integrity of the ontology, the system may also include a named entity filtering mechanisms that can prevent brand names, product names, or other proper nouns from being misclassified as general attributes or categories. This may be accomplished using named entity recognition (NER) models and curated exclusion lists, ensuring that terms like “Nike” or “iPhone” are not erroneously grouped with attributes such as “comfortable” or “durable.”

These enhancements may be integrated into the system's iterative ontology refinement loop, which includes embedding-based similarity scoring, Magic Matrix transformation, and dynamic UI validation tools, such that they can enable the system to construct a robust, semantically coherent ontology that adapts to evolving language and domain-specific usage patterns.

### Impact Training:

The processing system 110 may generate a refined ontology datastructure and use it to replace less frequently occurring topics with their parents. The entity data post the replacement operation may be used to create a pivot matrix, with the rows as review/text ids, and the topics as features, with each topic's summed sentiment value in each cell. This may be the X matrix used in relation to impact model training (The y matrix being the corresponding rating of the reviews). Using various methods, such as XGBoost Regressor, the processing system 110 may then regress the “sentiment representation of topics inside the review” against the rating. The processing system 110 may perform hyperparameter tuning to obtain the best set of hyperparameters for XGBoost. After training, the SHAP value may be used to generate the XGBoost tree explainer and obtain the review x feature SHAP values, which may attribute to a feature's contribution towards the average rating.

TABLE 4
(illustration of X matrix)

| Review ID | Taste | Smell | Texture | Price |
|---|---|---|---|---|
| 1 | 1 | Nan | 0 | 1 |
| 2 | −1 | 0 | Nan | −1 |
| 3 | Nan | Nan | Nan | 1 |

TABLE 5
(illustration of y matrix)
Y
5
1
3

The processing system 110 may use, from the previous step, the SHAP or Transformer Attribute values to generate concept-level impact across a specified population. For each topic inside a population, the processing system 110 may multiply the average SHAP of the topic with its “mentions percentage” to achieve a “leaf level, pre-normalized impact value.” The processing system 110 may then normalize the leaf level impact values for all topics to make the positives to the max KPI score, and the negatives to the difference between the average and the max KPI scores. These normalized impact values may be upward-aggregated, to ensure that the child topics' impact values (when aggregated) are to be equal to that of the parents.

In some embodiments, the impact training module of the processing system 110 includes mechanisms to resolve sentiment ambiguity and uncover high impact but infrequent concepts that may otherwise be overlooked in traditional modeling approaches. These enhancements may improve the system's ability to generate actionable insights for brand strategy, innovation, and white space identification.

One such enhancement may address the issue of polarization cancellation, which can occur when opposing sentiment extremes associated with the same concept (e.g., “too expensive” vs. “cheap”) are averaged out, resulting in a misleadingly neutral net sentiment. To mitigate this, the system may separately model sentiment polarities for each concept and tracks their directional impact independently. For example, the concept “price” may be associated with both positive and negative sentiment clusters, each contributing distinct SHAP values to the overall impact model. This may allow the system to reveal nuanced consumer perceptions and identify polarizing attributes that may warrant targeted messaging or product differentiation.

Additionally, or alternatively, the system may “relax” or remove the low-frequency filter typically used to exclude rare concepts from impact modeling. Instead, it can employ importance sampling and contextual amplification techniques to elevate the visibility of low-frequency but high-impact features. Importance sampling prioritizes concepts that, despite their rarity, exhibit strong correlation with key performance indicators (e.g., review ratings, NPS). Contextual amplification leverages co-occurrence patterns and semantic proximity to reinforce the relevance of these concepts within the broader analytic framework. For example, a seldom-mentioned phrase such as “biodegradable packaging” may appear in only a handful of reviews but be strongly associated with high sentiment and brand loyalty. The system may identify this signal through its contextual linkage to sustainability-related concepts and may surface it as a strategic opportunity for brand innovation. These refinements may be integrated into the SHAP-based impact modeling pipeline described herein and may be compatible with the ontology refinement and emotion inference modules.

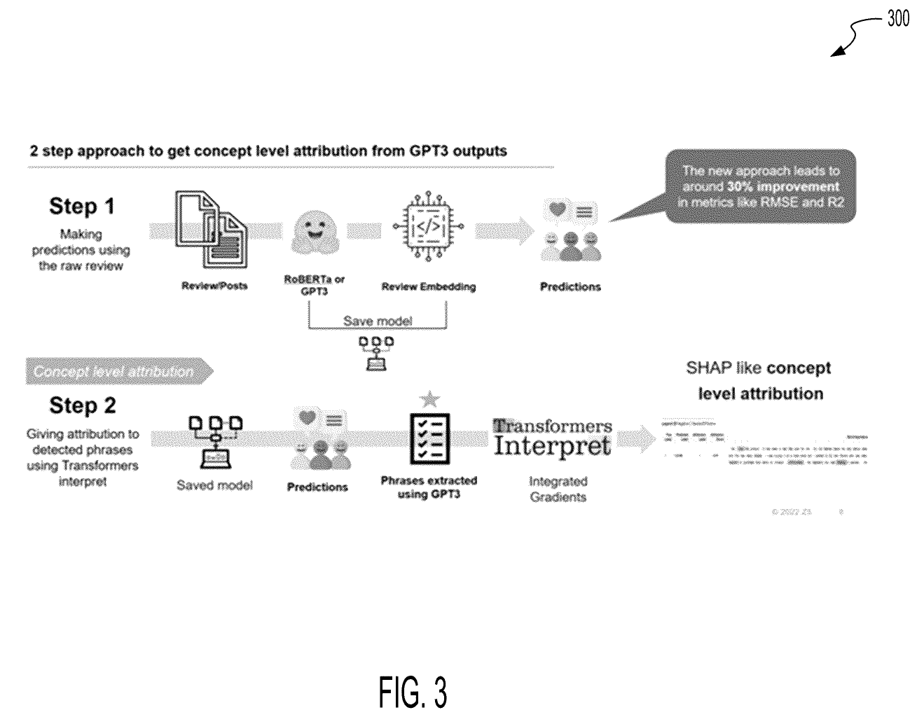

In some embodiments, the processing system 110 may use a UI population pipeline (depicted in FIG. 3) that includes the general/master data frame (entity data), the ontology, and the product dimensions database. Using the pipeline, the processing system 110 can generate different tables and UIs discussed and depicted herein. The views generated may contain information tables, such as the review modal tables, review summary tables, related topics tables, trend and impact, trend segments, seasonality, waterfall, executive summaries, audience profiling tables, brand summaries, and brand performance tables. A second divergent element of this pipeline may be a driver file, that creates summaries across different population segments, and populates an Excel workbook, which can be used to refine the ontology. For instance, a review man manually refines the ontology by reviewing the insights and/or populating the Business Decks, which are shared with the clients as read-outs.

In addition to quantitative impact scoring and sentiment attribution, the processing system 110 may also be configured to generate higher-order strategic outputs derived from the underlying analytic signals. These outputs may include, but are not limited to, messaging concepts, innovation ideas, and white space opportunities, which are synthesized from patterns in sentiment, emotion, and trend data across consumer language. The system 110 may continuously monitor and analyze the evolution of audience language, including emerging phrases, shifting sentiment clusters, and novel concept associations. Using this information, the system 110 may identify recurring themes and unmet needs that may not be explicitly stated but are implied through linguistic patterns and emotional tone. These insights may then be abstracted into messaging frameworks or product innovation prompts that can be used by marketing, product, or strategy teams. For example, if the system 110 detects a growing cluster of positive sentiment around phrases like “easy to recycle,” “compostable,” and “zero waste,” it may generate a messaging concept such as “effortless sustainability” or suggest a product innovation direction focused on biodegradable packaging. These outputs are not limited to existing ontology nodes but may include inferred or extrapolated concepts based on semantic proximity and contextual amplification.

In some embodiments, the strategic outputs may be presented through the user interface alongside traditional analytics, allowing users to explore the rationale behind each suggestion via supporting quotes, sentiment trajectories, and concept co-occurrence maps.

The impact modeling module may extend beyond traditional sentiment classification by quantifying the contribution of individual topics to an overall performance metric, such as a star rating. This approach may enable a more granular and actionable understanding of consumer satisfaction by attributing portions of the total score to specific product or experience attributes. Unlike conventional sentiment analysis systems that rely on keyword frequency or polarity scoring, the system 110 may distribute the share of a possible five-star rating across multiple underlying topics extracted from unstructured text. Each topic—such as “gluten-free,” “price,” or “customer service”—may be assigned a weighted contribution based on its sentiment intensity, frequency, and contextual relevance within the review. These contributions may be positive or negative and are aggregated to reconstruct the overall rating with topic-level transparency.

For example, a review that assigns a product a 4-star rating may include both praise for its “gluten-free” formulation and criticism of its “high price.” In some embodiments, the system identifies these topics, evaluates their sentiment polarity and strength, and assigns proportional impact values—e.g., +1.2 stars for “gluten-free” and −0.8 stars for “price”—such that the sum of all topic contributions approximates the observed rating. This decomposition allows stakeholders to understand not just what consumers feel, but why they feel that way.

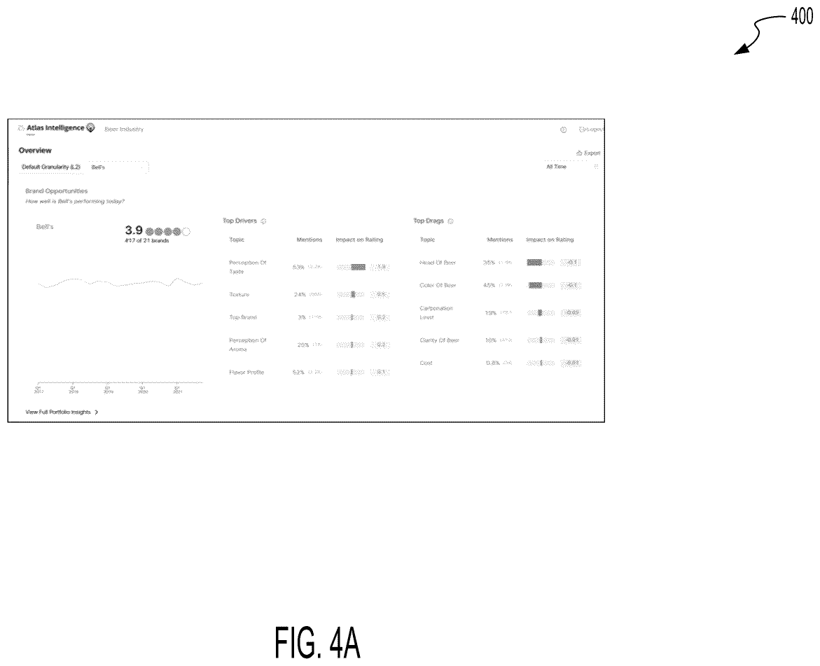

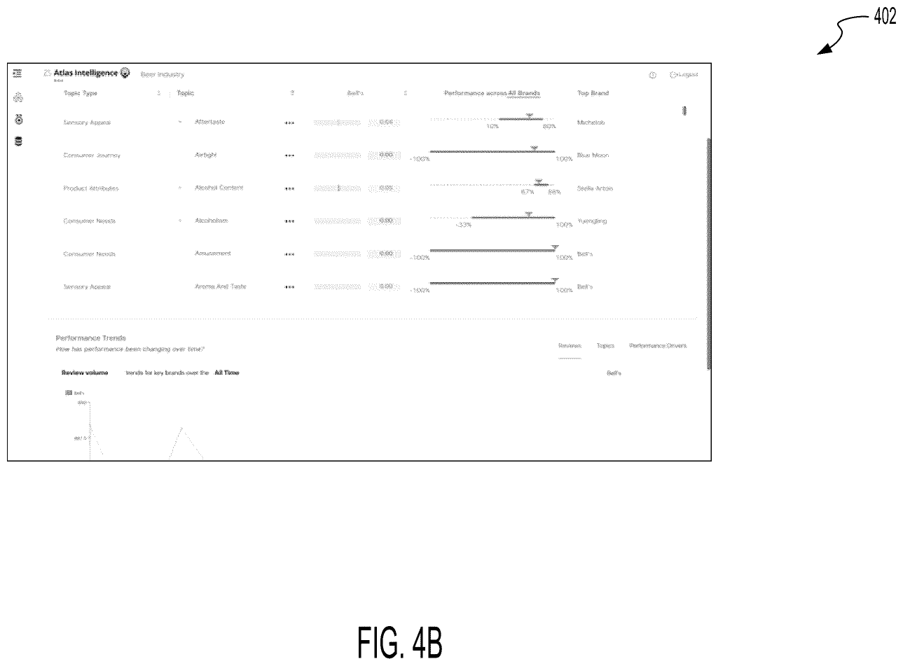

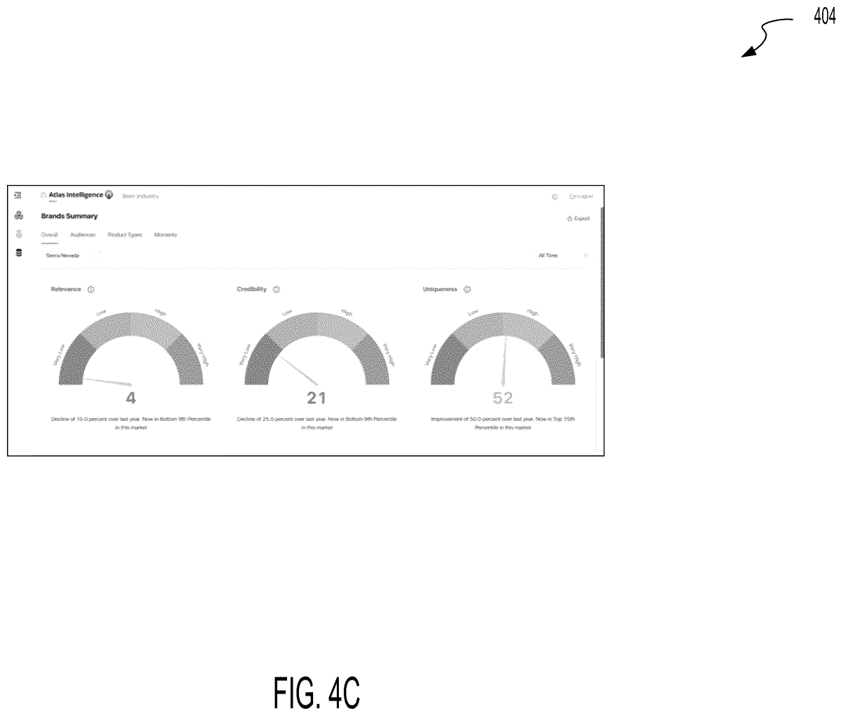

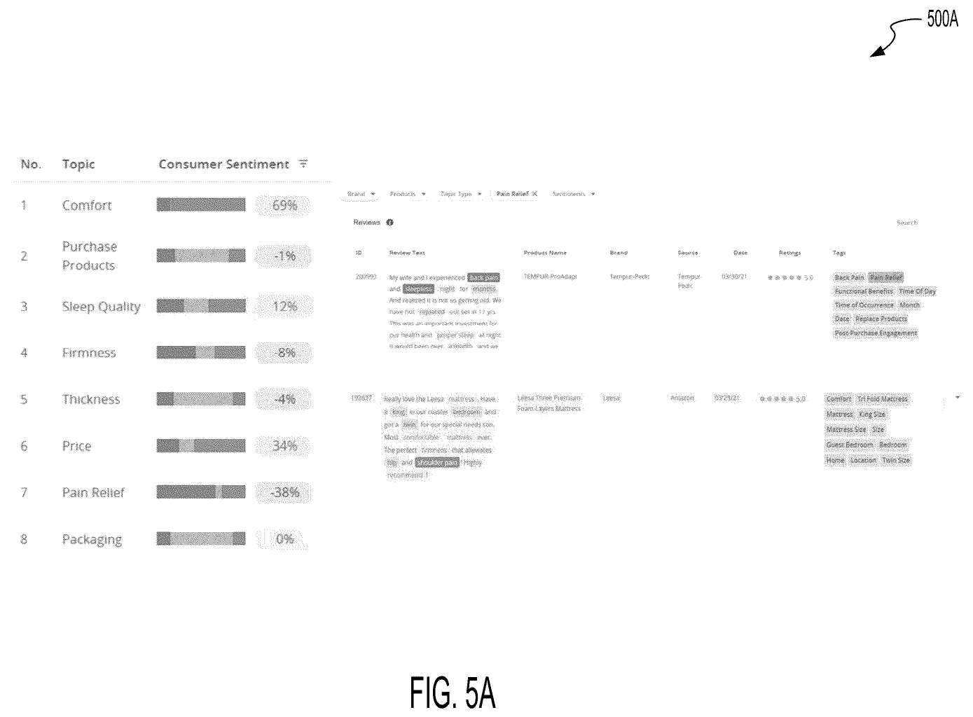

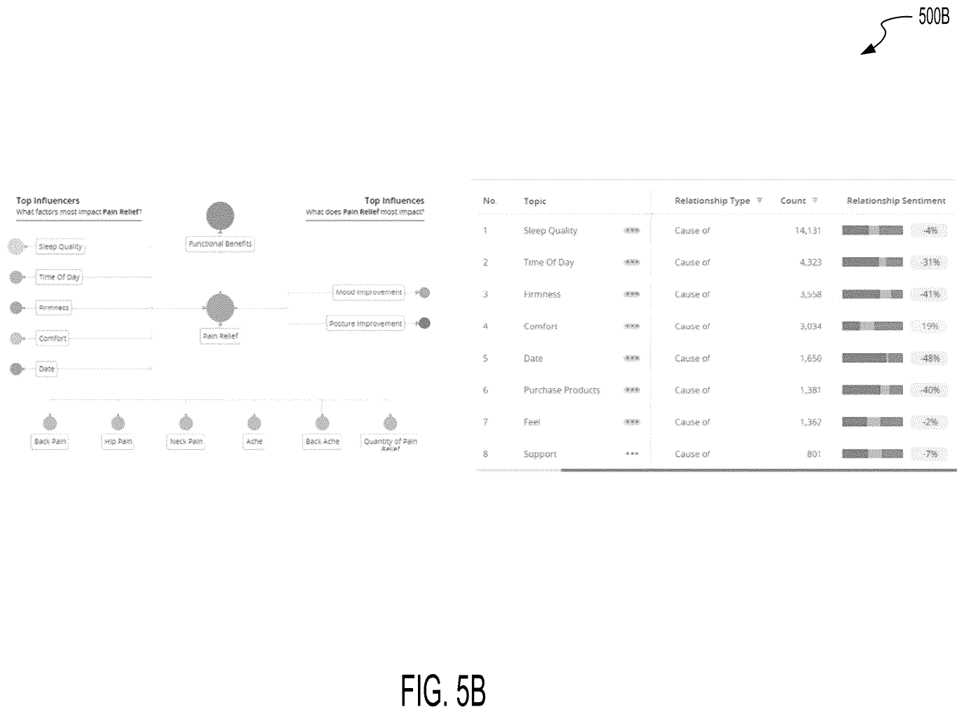

The same process may be automatically performed by the processing system 110. Non-limiting examples of user interfaces are depicted in FIGS. 4A-5B.

The UI, depicted in FIG. 4A may be populated on the data from the Beer industry. However, the methods discussed herein apply to any other industry. The UI 400 can be hosted with data from that relevant industry. As depicted, the UI 400 may include “Brand Opportunities” that define how well a brand such as Bell's, Blue Moon is performing today. The UI 400 may also include “Top Drivers” which defines the topics with the most positive impact on the Brand's rating. The UI 400 may also include “Top Drags” that define the topics with the most negative impact on the Brand's rating. The UI 400 may also include “Brand KPI Benchmarking” which defines the top-performing brands in that category. The UI 400 may also include “Market Opportunities” which defines the largest opportunities of topics in that category. Accordingly, the UI 400 may comprise white spaces, table stakes, and trending topics.

In some embodiments, the user interface 400 includes an advanced ontology editing environment that enables users to interactively refine the system's conceptual hierarchy using intuitive visualization tools. This environment may replace traditional spreadsheet-based workflows with a dynamic, real-time interface that supports drag-and-drop node manipulation, contextual previewing, and predictive editing capabilities. The ontology editor may allow users to view the full structure of the hypothesized or refined ontology as a navigable tree or graph. Each node in the ontology is represented visually and can be repositioned or reclassified by dragging it to a new parent node or dimension. This drag-and-drop functionality is supported by real-time validation logic that ensures semantic consistency and prevents structural conflicts.

To assist users in evaluating the appropriateness of each node's placement, the UI 400 may provide contextual example quotes, phrase frequency histograms, and relationship trees. When a user selects a node, the system 110 may display representative text excerpts from the underlying corpus that contributed to the node's creation, along with the most common phrases associated with that concept. This allows users to assess the linguistic and semantic context of each node before making changes.

The UI 400 may also include predictive filtering and predictive node suggestions, which can leverage the same LLM-generated embeddings and Magic Matrix transformations described herein. For instance, as users interact with the ontology, the system 110 may dynamically recommend potential parent nodes, sibling concepts, or related dimensions based on cosine similarity and co-occurrence patterns (or other paradigms). These recommendations may be visually highlighted in the UI 400 and can be accepted or dismissed with a single click. For example, if a user is editing a node labeled “gut-friendly,” the system may suggest linking it to the “digestive health” cluster under the “Consumer Needs” dimension, based on prior embedding similarity and usage patterns. Similarly, if a new concept such as “plant-based packaging” is introduced, the system 110 may recommend its placement under both “Sustainability” and “Packaging Attributes,” enabling multi-dimensional classification.

The UI 400 may provide an interactive tool designed to support collaborative refinement sessions, where multiple stakeholders may be reviewing and finalizing the ontology structure. By providing real-time feedback and intelligent suggestions, the UI 400 may accelerate the ontology development process and ensure that the resulting structure is both semantically robust and human interpretable.

In another example, as depicted in FIG. 4B, a UI 402 provides the performance benchmarking indicating how the brands and products perform relative to competitors. Using the UI 402, a user can filter down the data with each topic type, topics, performance across all brands, the top brands, and the like. The UI 402 may provide the performance trends of the brands over a maximum period of 4 years (or any other time window provided by the user). As depicted, the performance drivers are also captured.

In another example, as depicted in FIG. 4C, a UI 404 provides the brand-related summary. Users can select the brand and can get insights related to that brand. Users can toggle between the category of audiences, product types, and moments. Brand Summary may capture the following KPIs:

Brand Relevance measures how well a brand delivers on what is most important to consumers in aggregate.

Brand Credibility measures the degree to which consumers believe a brand can effectively deliver on topics in the category, regardless of how important those topics are in aggregate.

Brand Uniqueness measures how different this brand is from all other brands in the category.

Referring now to FIG. 5A in the context of the components described in FIG. 1, depicted is an example user interface showing entities extracted from unstructured text data (e.g., product reviews) and sentiment values generated based on the unstructured text data using the machine-learning models (LLM) described herein, according to an embodiment. As shown, the entities extracted using the techniques described herein can be ranked according to their frequency in product reviews. In an embodiment, an interface such as the one shown in FIG. 5A can be generated for each product, brand, or market under analysis (e.g., which may be specified by user input at a computing device such as the user device 160 of FIG. 1). For example, an operator may request information about a particular product, and the processing system 110 can generate and transmit a user interface showing the sentiment analysis for entities extracted from reviews of that product.

The ranked entities can be displayed with a representation of the aggregate sentiment values from each review. In an embodiment, the sentiment values (e.g., positive or negative) can be shown in different colors (e.g., green for positive, red for negative). The user interface may show a percentage of the sentiment values that are positive relative to the percentage of sentiment values that are negative for any given entity or concept. The user interface may also enable the user to apply various filters via interactive user interface elements. For example, the user may filter reviews or entities by product, brand, topic type, and sentiment values, or may view groups of reviews for several different products that may include common entities.

As shown in FIG. 5A, the user has selected “Pain Relief” as a filter concept, and the user interface shows reviews for mattresses that include the “Pain Relief” topic. Each displayed review can include a review identifier, the review text, the product brand, the product name, the source of the review (e.g., a data source 180), the date of the review, the review rating, and tags associated with each review. Words in the review text that indicate one or more identified entities may be highlighted with a color.

The highlight color can correspond to the sentiment value generated for that entity in that review (e.g., green for positive sentiment, red for negative sentiment, gray for neutral sentiment, etc.). In an embodiment, the ranking of frequently identified entities can change according to the filter criteria specified by the user (e.g., to include only the ranked entities that appear in reviews that satisfy the filter criteria).

Referring now to FIG. 5B in the context of the components described in FIG. 1, depicted is an example user interface showing entities extracted from unstructured text data (e.g., product reviews), relationships between the extracted entities, and sentiment values generated for those relationships. The user interface can be generated in response to a request received from the user device 160. For example, an operator may request information about a particular product, entity, concept, or brand, and the processing system 110 can generate and transmit a user interface showing the relationship analysis for corresponding entities. The user interface in FIG. 5B can indicate relationships between entities in a graph format. In an embodiment, the user can select one or more entities via the user interface, and the user interface can show the relationships between the selected entity and other entities extracted from product reviews.

As shown in FIG. 5B, the user has selected “Pain Relief” as the entity for which to generate a relationship graph. The processing system 110 has generated and ranked entities according to their association with the selected entity (here, “Pain Relief”). The entities may be ranked according to an estimated impact on the selected entity (e.g., “Top Influencers”), and the entities may also be ranked according to the estimated impact that the selected entity has (e.g., “Top Influences”).

The ranked entities can be displayed with a representation of the aggregate sentiment values from each review. In an embodiment, the sentiment values (e.g., positive or negative) can be shown in different colors (e.g., green for positive, red for negative). The user interface may show a percentage of the sentiment values that are positive relative to the percentage of sentiment values that are negative for any given entity or concept. The user interface may also enable the user to sort the listed entities according to various criteria. For example, the user may sort the listed entities by relationship type, count (e.g., frequency of appearance in product reviews), and relationship sentiment, among others. The aggregate positive, negative, and neutral sentiment contribution of each entity can be indicated using respective colors. The user interface may show a percentage of the sentiment values that are positive relative to the percentage of sentiment values that are negative for any given entity or concept.

Referring back to FIG. 1, the processing system 110 can utilize the information generated by the machine-learning model 115 (e.g., following execution by the model executor 116), to generate forecast data for different entities. The forecast can be implemented using a time-series univariate forecasting technique, which may be applied to the mentioned data of each concept/entity extracted from the product reviews for a particular brand, product, data source, or product type. The processing system 110 may also identify a topic as a trend, size the magnitude and directionality of the trend, categorize the nature of the trend (emerging, declining, and/or flagging seasonal trends), categorize the nature of seasonal trends (annual vs. quarterly), peak period(s), forecasting future growth based on the above.

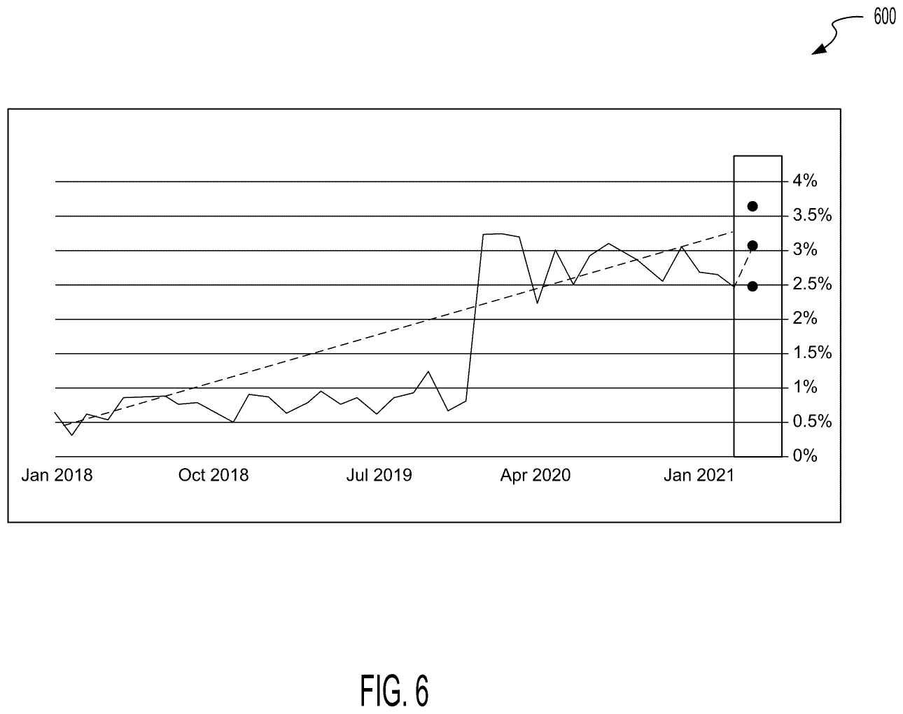

The processing system 110 can estimate a trend slope, which can be provided as a trend insight on one or more user interfaces. An example time-series graph for an example concept is shown in FIG. 6, which depicts the output of the univariate forecasting on the mentions data of an example concept or entity extracted from product review data. An example input data structure for the forecasting technique and an example output data structure of the forecasting technique are shown below in Tables 9 and 10.

TABLE 4

| Brand | Concept | Mentions Data (e.g., time series) |
|---|---|---|
| Zinus | Pain Relief | {2019-01: 100, 2019-02: 150, |
| | | 2019: 03: 122: . . . 2021: 03: 500} |
| Zinus | Comfort | {2019-01: 1111, 2019-02: 1500, |
| | | 2019: 03: 1228: . . . 2021: 03: 5000} |
| Zinus | Odor | {2019-01: 0, 2019-02: 0, |
| | | 2019: 03: 12: . . . 2021: 03: 50} |

TABLE 5

| | | Trend | QoQ | Trend | Total |
|---|---|---|---|---|---|
| Brand | Concept | Score | Growth | Type | Mentions |
| Zinus | Pain | 0.02 | 0.05% | Stable | 1000 |
| | Relief | | | | |
| Zinus | Comfort | 0.01 | 0.10% | Stable | 10900 |
| Zinus | Odor | 0.17 | 14% | Increasing | 230 |

In addition to calculating trend data, the processing system 110 can utilize the sentiment values generated by the LLM and the review ratings to estimate the overall impact of each respective entity/concept on the rating of each product. To do so, the processing system can generate a sentiment array that includes sentiment values for each entity extracted from each review of a particular product, and a ratings array that includes ratings for each review of the particular product. The processing system 110 can then calculate the SHAP values between the entity array and the rating array to determine the impact of the sentiment of each entity/concept on the ratings. For instance, a driver model (e.g., XGBoost) may take in as inputs the entity data, the associated sentiment, and the associated KPI (e.g., rating or NPS). The model then uses that input to predict KPI values based on the presence of the entity and its associated sentiment.

Once that model has been developed, SHAP values may be used to size the relative importance of each feature in the model prediction. Subsequently, various normalization processes may be executed, such that the processing system 110 can quantify the contribution to the average KPI for a given population (total market, brand, product, etc.).

Additionally, the processing system 110 can calculate the average sentiment for each concept corresponding to a particular product. An example input data structure to the impact calculation process is shown in Table 6 below and an example output data structure including outputs of the impact calculation process is shown in Table 7 below.

TABLE 6

| Review ID | Concept | Sentiment | Ratings |
|---|---|---|---|
| 1 | Pain Relief | +1 | 5 |
| 2 | Pain Relief | +1 | 4 |
| 3 | Pain Relief | −1 | 1 |

TABLE 7

| Concept | Net Sentiment | Impact |
|---|---|---|
| Pain Relief | +1 | 5 |
| Comfort | +1 | 4 |
| Smell | −1 | 1 |

The processing system 110 can store these values in one or more data structures in association with an identifier of the product, manufacturer, retailer, market, data source, brand, or other product-relevant information. The impact score and average sentiment information calculated for each concept can be presented to a user in one or more user interfaces, such as the user interfaces shown in FIGS. 5A and 5B.

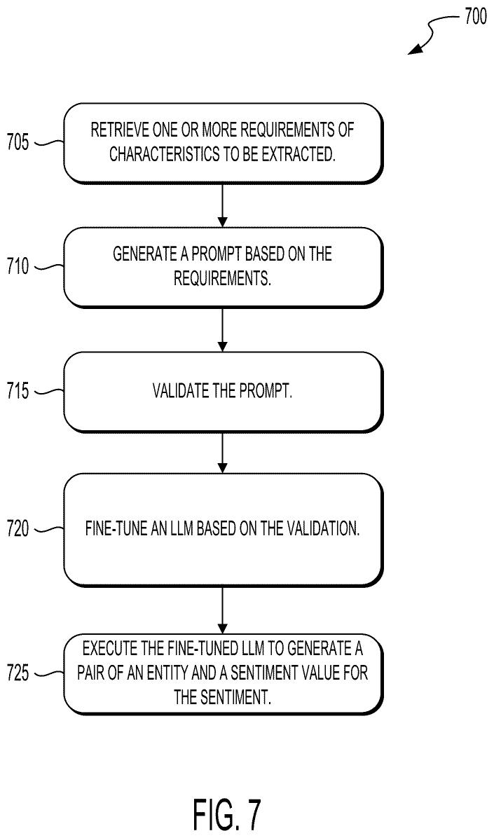

Referring to FIG. 7, illustrated is a flowchart illustrating a method 700 of generating interpretable outputs from unstructured data, according to an embodiment. The method 700 can be performed by a processor of a processing system (such as the processor 113 of the processing system 110 as shown and described with respect to FIG. 1). Although the method 700 is shown as including steps 705-725, it should be understood that in some implementations, the steps 705-725 may be performed in a different order, or steps or operations may be omitted altogether.

The method 700 can include retrieving, at step 705, one or more requirements of knowledge to be extracted.

The method 700 can include generating, at step 710, a prompt corresponding to the one or more requirements.

The method 700 can include validating, at step 715, the prompt by executing a large language model using the prompt and evaluating the response predicted by the large language model.

The method 700 can include fine-tuning, at step 720, the large language model using validation data generated as a result of validating the prompt.

The method 700 can include executing, at step 725, the fine-tuned large language model using a text corpus to analyze one or more item reviews and generate a pair of at least one entity and a respective relationship sentiment value for the entity.

The method 700 can include generating one or more pairs of entities and a respective relationship sentiment value based on the outputs of the machine-learning model. These relationship sentiment values may be presented to a user (e.g., in response to a request from a user device 160) in one or more user interfaces, such as the user interfaces described in connection with FIGS. 4A-5B. The method 700 can include generating forecast data based on the entities generated by the machine-learning model and the item reviews, as described herein. The forecast data can be an estimate of a frequency that an entity appears in one or more item reviews for a particular item based on the previous occurrences of that entity in the item reviews for that item. The method 700 can include generating an impact score for the entities associated with a particular item. The impact score can be determined based on a SHAP value calculated from the ratings in the item reviews for a particular item, and the sentiment values for entities extracted from the item reviews for the particular item. The sentiment values, forecast data, and impact scores can be presented in one or more user interfaces (e.g., in response to a request), such as the user interfaces described in connection with FIGS. 4A-5B.

To support scalability across large-scale deployments, the disclosed methods and systems may incorporate a suite of runtime optimization techniques designed to reduce processing latency and improve throughput when handling datasets comprising millions of unstructured inputs. These optimizations may be used for maintaining performance and responsiveness in production environments where real-time or near-real-time analysis is required.

In one embodiment, the method 700 leverages parallel processing to distribute computational workloads across multiple processing units or threads. This enables concurrent execution of key pipeline stages such as phrase extraction, sentiment tagging, and ontology mapping, thereby reducing overall execution time. The method 700 may also implement selective inference, wherein only relevant portions of the input data are passed through computationally intensive models (e.g., large language models or fine-tuned transformers). This may be achieved through lightweight pre-filters or heuristics that identify high-value segments of text, allowing the system to bypass unnecessary inference steps for low-priority or redundant content.

In some embodiments, to further reduce latency, the method 700 may employ caching mechanisms that store intermediate results, such as previously computed embeddings, prompt completions, or ontology mappings. These cached results may be reused across sessions or similar inputs, eliminating redundant computations and accelerating repeated queries. Additionally, the method 700 may incorporate token-level cost optimization, which includes techniques such as prompt compression, token truncation, and dynamic prompt shaping. These methods reduce the number of tokens processed by the language model, thereby lowering both computational cost and latency without compromising output quality. Collectively, these runtime optimizations may enable the system discussed herein to scale efficiently across large datasets and high-throughput environments, ensuring that insights can be generated quickly and cost-effectively even as data volume grows.

In some embodiments, to further enhance system responsiveness and efficiency, the method 700 includes an adaptive caching mechanism (e.g., powered by a lightweight, continuously trained machine learning model). Unlike traditional caching strategies that rely solely on recency or frequency of access, this adaptive cache can anticipate future data requests based on semantic patterns observed in system behavior. The predictive model may evaluate contextual signals such as code execution paths, user interaction sequences, and workload trends to forecast which data elements—such as embeddings, prompt completions, or ontology mappings—are likely to be needed next. By proactively caching these predicted elements, the method 700 may reduce latency associated with repeated or anticipated queries. The model may be updated incrementally using real-time telemetry from the pipeline, allowing it to adapt to evolving usage patterns and maintain high prediction accuracy over time. This intelligent caching approach can improve throughput and resource utilization, particularly in high-volume environments where inference costs are non-trivial.

In some embodiments, the architecture discussed herein (e.g., the processing system 110) includes an adaptive caching subsystem configured to reduce latency and improve throughput during runtime execution of the machine-learning pipeline. The adaptive caching system described herein may utilize a lightweight, continuously trained machine-learning model to predict future data access patterns based on semantic and behavioral signals. The predictive model may be implemented as a shallow neural network or other suitable learning algorithm and may be trained on telemetry data collected from prior executions of the pipeline. This data may include, but is not limited to, the sequence of prompt invocations, the types of entities extracted, the ontology traversal paths, and the frequency and timing of user queries. The model may learn to associate these patterns with downstream data access needs, enabling it to forecast which intermediate results—such as embeddings, prompt completions, or ontology mappings—are likely to be requested in the near future.

In some implementations, during a collaborative review session, the system discussed herein may observe that certain prompt templates and their associated completions are repeatedly accessed. The adaptive cache can proactively store these completions and their embeddings, reducing the need for repeated inference calls to the LLM discussed herein. Similarly, if the system detects a trend in workload behavior—such as a spike in requests related to “consumer needs” or “product features”—it may preemptively cache the relevant ontology nodes and their embeddings.

In some embodiments, the adaptive cache may be continuously updated using a feedback loop. As actual access patterns are observed, the model is retrained or fine-tuned to improve its predictive accuracy. This allows the caching strategy to evolve in tandem with changing usage patterns, such as those that may arise from new product lines, seasonal trends, or evolving user behavior.

In some embodiments, the adaptive cache is integrated with the model executor 116 and operates in conjunction with the token-level cost optimization and selective inference modules described elsewhere in this specification. Together, these components may enable the system to scale efficiently across datasets comprising millions of unstructured inputs, while maintaining low latency and high responsiveness.

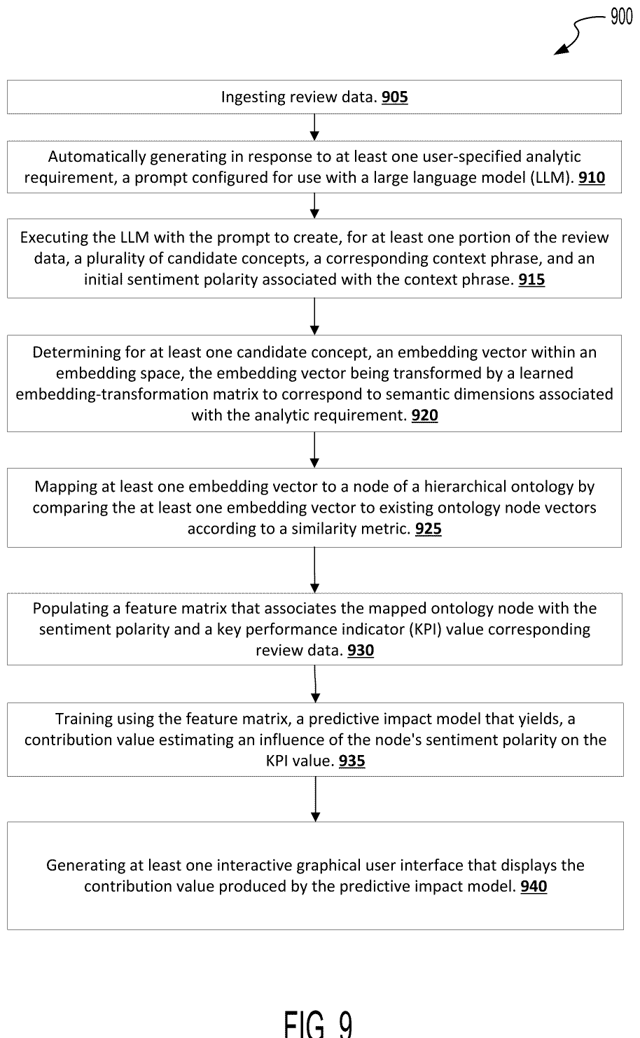

FIG. 9 is a flowchart of an example method 900 for a computer-implemented method for generating interpretable analytic outputs from unstructured data, the method comprising. The method 900 is described as being executed by a system (similar to the system 100). However, in other embodiments, the method 900 can be executed by any computing device, such as other electronic devices discussed herein.

At step 905, the system may ingest review data. In an initial acquisition stage, the system may communicate with a plurality of review-bearing endpoints, thereby retrieving raw, text-based review payloads together with any associated metadata fields (e.g., star rating, product identifier, submission timestamp).

In certain implementations, ingesting the review data may comprise the system retrieving unstructured text from a plurality of heterogeneous sources, including but not limited to: (i) e-commerce websites, where headless scraping agents or various APIs pull item reviews, star ratings, and product identifiers; (ii) social-media platforms, where the system subscribes to streaming endpoints or scheduled export utilities to capture posts, comments, and associated engagement metrics; (iii) voice-of-customer surveys, where CSV or JSON exports containing open-ended responses; (iv) call-center environments, where batch or real-time feeds deliver speech-to-text transcripts together with call-length and case-resolution metadata; and/or (v) investor-relations repositories, where optical-character-recognition and text-segmentation routines parse PDF or HTML earnings reports to isolate sentiment-laden commentary.

At step 910, the system may automatically generate, in response to at least one user-specified analytic requirement, a prompt configured for use with a large language model (LLM). The system may receive at least one analytic requirement supplied through a graphical configuration interface—e.g., “extract consumer-need phrases and assign sentiment”—and automatically invokes a prompt-generation engine. The engine may parse the free-form requirement into a structured directive comprising (i) a target analytic dimension, (ii) an extraction or classification task, and (iii) a mandated output schema. The system may then identify internal repository of validated prompt (e.g., completion pairs to assemble a bounded set of illustrative examples that match the directive and collectively remain below a predefined token budget). In some embodiments, a token-optimization module may subsequently rewrite verbose instructions, collapse redundant clauses, and/or substitute macro identifiers for boiler-plate text, thereby ensuring that the fully populated prompt complies with the maximum-token constraint imposed by the downstream LLM. Upon completion of the optimization pass, the system may interpolate the chosen examples and dynamic variables into the skeleton, append an explicit output-format declaration (e.g., strict JSON array), and assign the finished instruction set a unique PromptID.

At step 915, the system may execute the LLM with the prompt to create, for at least one portion of the review data, a plurality of candidate concepts, a corresponding context phrase, and an initial sentiment polarity associated with the context phrase. The system may transmit the populated prompt, together with at least one normalized review object, to the LLM (e.g., via an authenticated application-programming-interface (API)) call. Prior to transmission, the system may apply a selective-inference filter that partitions lengthy review text into token-bounded segments, thereby preventing overflow of the provider's maximum-context window. Once the request is submitted, the LLM may return a structured completion that, for each processed text segment, includes (i) a plurality of candidate concepts explicitly surfaced in the review, (ii) a context phrase that surrounds or summarizes each concept, and (iii) an initial sentiment polarity—Positive, Negative, or Neutral—assigned in accordance with the examples embedded inside the prompt.

In some embodiments, the system may further fine-tune the underlying LLM by assembling a bespoke training corpus of prompt-completion pairs, each pair constructed from candidate concepts and their associated sentiment polarities that have already passed schema and confidence validation. By training the model on domain-specific examples that mirror (or at least correspond to) the prompt structure and output schema enforced in production, the system may align the LLM's internal weights with the ontology and sentiment conventions of the pipeline, thereby boosting concept-extraction precision while allowing future inference calls to omit few-shot examples, which in turn lowers token counts, decreases latency, and reduces per-request computational cost.

At step 920, the system may determine for at least one candidate concept, an embedding vector within an embedding space, the embedding vector being transformed by a learned embedding-transformation matrix to correspond to semantic dimensions associated with the analytic requirement. The system may iterate through the candidate concepts accepted during LLM execution and, for each concept, consult an embedding cache to determine whether a pre-computed vector already exists. When the vector is absent, the system may invoke an embedding-generation service—such as a transformer-based sentence-encoder—to create a base embedding that situates the concept in a high-dimensional semantic space. The system may multiply the base embedding by a previously learned embedding-transformation matrix (“Magic Matrix”) that weights or suppresses specific dimensions so that the resulting vector aligns with the semantic priorities implicit in the current analytic requirement (e.g., consumer needs versus product attributes). Upon completion of the transformation, the system may normalize the vector to unit length, assign a persistent EmbeddingID, and write the vector, together with its concept label and provenance metadata, into an embedding pool stored in memory.

At step 925, the system may map at least one embedding vector to a node of a hierarchical ontology by comparing the at least one embedding vector to existing ontology node vectors according to a similarity metric. The system may retrieve the transformed embedding vector and perform a similarity search against a repository of ontology-node vectors that collectively define the current hierarchical ontology. During this search, the system may compute a similarity metric—such as cosine similarity—for the candidate vector relative to every node vector contained within the same top-level dimension (e.g., Consumer Needs, Product Features). Once the similarity scores are obtained, the system may identify the node whose score exceeds all others and is greater than a configurable threshold.

At step 930, the system may populate a feature matrix that associates the mapped ontology node with the sentiment polarity and a key performance indicator (KPI) value corresponding review data. The system may traverse each normalized review object and, for every concept that has been mapped to an ontology node, write an entry into a pivot-style feature matrix. At each coordinate (e.g., corresponding a particular node and particular review), the system may record a sentiment value derived from the LLM output and normalized under the rule set previously described—namely, +1 for phrases extracted from Positive buckets, −1 for phrases extracted from Negative buckets, and 0 for phrases extracted from Neutral buckets. When multiple phrases in the same review resolve to an identical node, the system may aggregate the individual values, for example by summing them, so that each review contributes a single consolidated polarity score per ontology node. Moreover, the system may pull the key-performance indicator (KPI) associated with that review—such as a star rating or net-promoter-score—and write it into a companion target vector that is index-aligned with the feature-matrix rows.

At step 935, the system may train, using the feature matrix, a predictive impact model that yields, a contribution value estimating an influence of the node's sentiment polarity on the KPI value. The system may load the matrix together with its aligned KPI vector and initiate a model-training routine. During an initial calibration pass, the system may perform k-fold cross-validation while sweeping a predefined hyper-parameter grid—covering tree depth, learning rate, and regularization coefficients—to identify the configuration that minimizes mean-squared-error on held-out folds. Once the optimal hyper-parameters are selected, the system may fit the regressor on the full training corpus, storing the resulting tree ensemble and all associated metadata as a versioned artefact in persistent storage.

In some embodiments, the predictive impact model is trained to forecast the review-level KPI that accompanies each piece of unstructured text—most commonly the star-rating value supplied by the reviewer, but, depending on the data source, it may instead be a Net Promoter Score, customer-satisfaction score, engagement count, call-duration metric, or any other numeric KPI captured alongside the text. During training the model may ingest, as inputs, the sentiment-weighted ontology-node features from the X-matrix and learns to minimize the error between its predicted KPI and the actual KPI in the y-vector; the resulting SHAP analysis then reveals how much each ontology node (topic) pushes that KPI prediction up or down.

At step 945, the system may generate at least one interactive graphical user interface that displays the contribution value produced by the predictive impact model. The system may output the predictions of the predictive model. A non-limiting example of (insert output example of FIG. 8A-B).

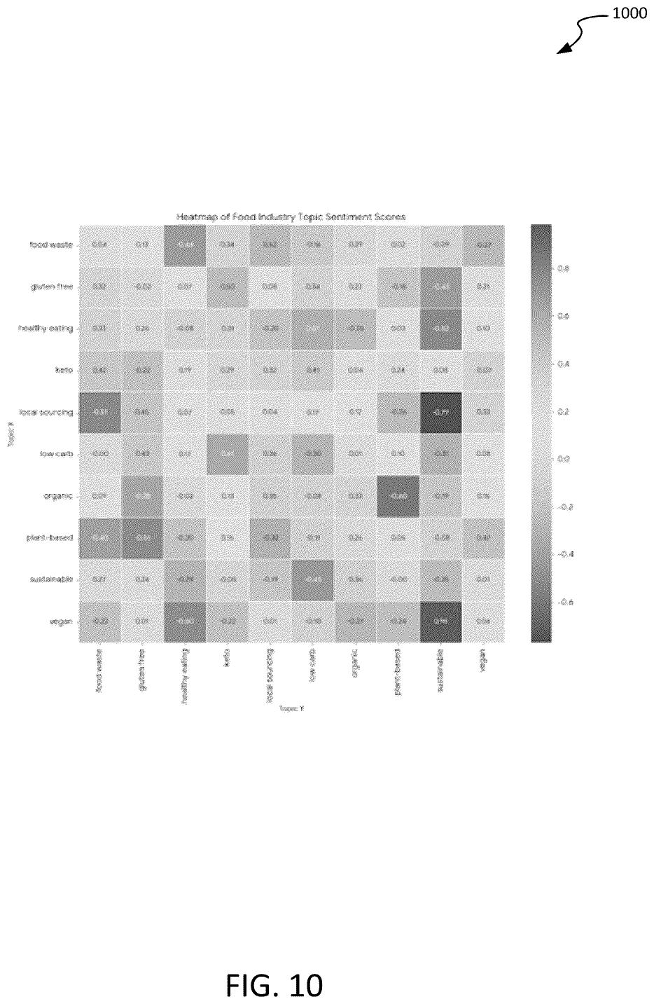

In addition to the structured tables illustrated in FIGS. 8A-8B, the system may be configured to generate alternative visual outputs—such as heatmaps—that enrich the interpretability of ontology-aligned data. These heatmaps provide intuitive representations of inter-topic sentiment or correlation patterns derived from the structured outputs. FIG. 10 exemplifies this functionality by depicting a sentiment-based heatmap across food industry topics, where each cell indicates the sentiment score associated with a given pair of concepts. Topics such as “vegan,” “organic,” “gluten free,” and “local sourcing” may be cross-analyzed to reveal nuanced sentiment relationships that may not be immediately evident in the raw structured table.

For example, FIG. 10 shows a strong positive sentiment correlation between “vegan” and “sustainable” (0.96), while “local sourcing” and “plant-based” exhibit a markedly negative sentiment relationship (−0.77), suggesting contrasting consumer perceptions despite thematic proximity. These heatmaps may be dynamically generated from the same underlying data structures as the tables in FIGS. 8A-8B, but offer a visual layer of insight that is especially useful for trend analysis, comparative benchmarking, and strategic segmentation. Outputs like FIG. 10 demonstrate how the system supports flexible, multimodal analytics by transforming extracted insights into both tabular and graphical formats.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized, and functional, logical, operational, organizational, structural, and/or topological modifications may be made without departing from the scope of the disclosure. As such, all examples and/or embodiments are deemed to be non-limiting throughout this disclosure.

Some embodiments described herein relate to methods. It should be understood that such methods can be computer-implemented methods (e.g., instructions stored in memory and executed on processors). Where methods described above indicate certain events occurring in a certain order, the ordering of certain events can be modified. Additionally, certain events can be performed repeatedly, concurrently in a parallel process, when possible, as well as performed sequentially as described above. Furthermore, certain embodiments can omit one or more described events.

All definitions, as defined and used herein, should be understood to control over dictionary definitions, definitions in documents incorporated by reference, and/or ordinary meanings of the defined terms.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for a specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field-programmable gate array (FPGA), and/or an application-specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include but are not limited to, micro-code or micro-instructions, machine instructions, such as those produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different from illustrated ones, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features apply to one aspect of the innovations and are inapplicable to others.

Where a range of values is provided, it is understood that each intervening value, to the tenth of the unit of the lower limit unless the context dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms indicated to the contrary, such as “only one of” or “exactly one of,” or when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and the embodiments, the phrase “at least one,” about a list of one or more elements, should be understood to mean at least one element selected from any one or more of the elements in the list of elements, but not necessarily including at least one of every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as outlined in the United States Patent Office Manual of Patent Examining Procedures, Section 2111.03.

What is claimed is:

1. A computer-implemented method for generating interpretable analytic outputs from unstructured data, the method comprising:
ingesting, by at least one processor, review data;
automatically generating, by the at least one processor, in response to at least one user-specified analytic requirement, a prompt configured for use with a large language model (LLM);
executing, by the at least one processor, the LLM with the prompt to create, for at least one portion of the review data, a plurality of candidate concepts, a corresponding context phrase, and an initial sentiment polarity associated with the context phrase;
determining, by the at least one processor, for at least one candidate concept, an embedding vector within an embedding space, the embedding vector being transformed by a learned embedding-transformation matrix to correspond to semantic dimensions associated with the analytic requirement;
mapping, by the at least one processor, at least one embedding vector to a node of a hierarchical ontology by comparing the at least one embedding vector to existing ontology node vectors according to a similarity metric;
populating, by the at least one processor, a feature matrix that associates the mapped ontology node with the sentiment polarity and a key performance indicator (KPI) value corresponding review data;
training, by the at least one processor using the feature matrix, a predictive impact model that yields, a contribution value estimating an influence of the node's sentiment polarity on the KPI value; and
generating, by the at least one processor, at least one interactive graphical user interface that displays the contribution value produced by the predictive impact model.

2. The method of claim 1, wherein ingesting the review data comprises retrieving unstructured text from a plurality of heterogeneous data sources corresponding to at least one of an e-commerce website, a social-media platform, a voice-of-customer survey, a call-center transcript, or an investor report.

3. The method of claim 1, wherein automatically generating the prompt further comprises selecting one or more representative few-shot examples and compressing the prompt to satisfy a predefined token budget.

4. The method of claim 1, wherein executing the LLM further comprises:
applying, by the at least one processor, a set of post-processing prompts to the plurality of candidate concepts to extract, at finer granularity, product attributes, consumer needs, occasions, or preparation methods.

5. The method of claim 1, wherein training the predictive impact model comprises fitting a gradient-boosted decision-tree regressor and computing SHAP values to derive the contribution value for each mapped ontology node.

6. The method of claim 1, further comprising:
fine-tuning, by the at least one processor, the LLM with a training corpus of prompt-completion pairs generated from validated candidate concepts and sentiment polarities, thereby reducing inference latency and improving concept-extraction accuracy.

7. The method of claim 1, further comprising:
executing, by the at least one processor, a runtime optimization protocol that employs parallel processing, selective inference of relevant text segments, and adaptive caching of intermediate results to reduce total processing latency and computational cost.

8. A computer system for generating interpretable analytic outputs from unstructured data, the computer system comprising a computer-readable medium having a set of non-transitory instructions that when executed, cause at least one processor to:
ingest review data;
automatically generate in response to at least one user-specified analytic requirement, a prompt configured for use with a large language model (LLM);
execute the LLM with the prompt to create, for at least one portion of the review data, a plurality of candidate concepts, a corresponding context phrase, and an initial sentiment polarity associated with the context phrase;
determine for at least one candidate concept, an embedding vector within an embedding space, the embedding vector being transformed by a learned embedding-transformation matrix to correspond to semantic dimensions associated with the analytic requirement;
map at least one embedding vector to a node of a hierarchical ontology by comparing the at least one embedding vector to existing ontology node vectors according to a similarity metric;
populate a feature matrix that associates the mapped ontology node with the sentiment polarity and a key performance indicator (KPI) value corresponding review data;
train, using the feature matrix, a predictive impact model that yields, a contribution value estimating an influence of the node's sentiment polarity on the KPI value; and
generate at least one interactive graphical user interface that displays the contribution value produced by the predictive impact model.

9. The computer system of claim 8, wherein ingesting the review data comprises retrieving unstructured text from a plurality of heterogeneous data sources corresponding to at least one of an e-commerce website, a social-media platform, a voice-of-customer survey, a call-center transcript, or an investor report.

10. The computer system of claim 8, wherein automatically generating the prompt further comprises selecting one or more representative few-shot examples and compressing the prompt to satisfy a predefined token budget.

11. The computer system of claim 8, wherein executing the LLM further comprises:
applying a set of post-processing prompts to the plurality of candidate concepts to extract, at finer granularity, product attributes, consumer needs, occasions, or preparation methods.

12. The computer system of claim 8, wherein training the predictive impact model comprises fitting a gradient-boosted decision-tree regressor and computing SHAP values to derive the contribution value for each mapped ontology node.

13. The computer system of claim 8, wherein the instructions further cause the at least one processor to:
fine-tune the LLM with a training corpus of prompt-completion pairs generated from validated candidate concepts and sentiment polarities, thereby reducing inference latency and improving concept-extraction accuracy.

14. The computer system of claim 8, wherein the instructions further cause the at least one processor to:
execute a runtime optimization protocol that employs parallel processing, selective inference of relevant text segments, and adaptive caching of intermediate results to reduce total processing latency and computational cost.

15. A computer system for generating interpretable analytic outputs from unstructured data, the computer system comprising at least one processor configured to:
ingest review data;
automatically generate in response to at least one user-specified analytic requirement, a prompt configured for use with a large language model (LLM);
execute the LLM with the prompt to create, for at least one portion of the review data, a plurality of candidate concepts, a corresponding context phrase, and an initial sentiment polarity associated with the context phrase;
determine for at least one candidate concept, an embedding vector within an embedding space, the embedding vector being transformed by a learned embedding-transformation matrix to correspond to semantic dimensions associated with the analytic requirement;
map at least one embedding vector to a node of a hierarchical ontology by comparing the at least one embedding vector to existing ontology node vectors according to a similarity metric;
populate a feature matrix that associates the mapped ontology node with the sentiment polarity and a key performance indicator (KPI) value corresponding review data;
train, using the feature matrix, a predictive impact model that yields, a contribution value estimating an influence of the node's sentiment polarity on the KPI value; and
generate at least one interactive graphical user interface that displays the contribution value produced by the predictive impact model.

16. The computer system of claim 15, wherein ingesting the review data comprises retrieving unstructured text from a plurality of heterogeneous data sources corresponding to at least one of an e-commerce website, a social-media platform, a voice-of-customer survey, a call-center transcript, or an investor report.

17. The computer system of claim 15, wherein automatically generating the prompt further comprises selecting one or more representative few-shot examples and compressing the prompt to satisfy a predefined token budget.

18. The computer system of claim 15, wherein executing the LLM further comprises:
applying a set of post-processing prompts to the plurality of candidate concepts to extract, at finer granularity, product attributes, consumer needs, occasions, or preparation methods.

19. The computer system of claim 15, wherein training the predictive impact model comprises fitting a gradient-boosted decision-tree regressor and computing SHAP values to derive the contribution value for each mapped ontology node.

20. The computer system of claim 15, wherein the processor is further configured to:
fine-tune the LLM with a training corpus of prompt-completion pairs generated from validated candidate concepts and sentiment polarities, thereby reducing inference latency and improving concept-extraction accuracy.
